(19) United States
(12) Patent Application Publication
(10) Pub. No.: US 2024/0267536 A1
(43) Pub. Date: Aug. 8, 2024

(54) METHOD, DEVICE, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Yang WANG, Beijing (CN); Kai ZHANG, Los Angeles, CA (US); Li ZHANG, Los Angeles, CA (US)

(21) Appl. No.: 18/564,507

(22) PCT Filed: May 26, 2022
(86) PCT No.: PCT/CN2022/095124

§ 371 Date: Nov. 27, 2023

(30) Foreign Application Priority Data
May 27, 2021 (WO) PCT/CN2021/096481

(51) Int. Cl. H04N 19/159; H04N 19/176

(52) U.S. Cl. CPC H04N 19/159; H04N 19/176

(57) ABSTRACT

Embodiments of the present disclosure provide a solution for processing video data. A method for processing video data is proposed. The method comprises: performing, during a conversion between a current block of a video and a bitstream of the video, an intra prediction for the current block based on at least one first parameter different from at least one second parameter used for an intra prediction of a normal angular mode, at least one extended angular mode being used for the current block; and performing the conversion based on the intra prediction mode. Compared with the conventional solution, the proposed method can advantageously improve the coding efficiency.

### FIELD

Embodiments of the present disclosure relates generally to video coding techniques, and more particularly, to intra prediction mode derivation.

### BACKGROUND

In nowadays, digital video capabilities are being applied in various aspects of peoples' lives. Multiple types of video compression technologies, such as motion picture expert group (MPEG)-2, MPEG-4, ITU-TH.263, international telecom union—telecommunication standardization sector (ITU-T) H.264/MPEG-4 Part 10 advanced video coding (AVC), ITU-T H.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide solutions for the intra prediction mode derivation.

In a first aspect, a method of processing video data is proposed. The method comprises: performing, during a conversion between a current block of a video and a bitstream of the video, an intra prediction for the current block based on at least one first parameter different from at least one second parameter used for an intra prediction of a normal angular mode, at least one extended angular mode being used for the current block; and performing the conversion based on the intra prediction mode. The method in accordance with the first aspect of the present disclosure enables that an extended angular mode may be derived and used for the current block. In this way, the precision of the intra prediction mode used by the current block is improved and the coding efficiency is improved thereby.

In a second aspect, another method of processing video data is proposed is proposed. The method comprises: determining, during a conversion between a current block of a video and a bitstream of the video, whether an extended angular mode is used for the current block. The method further comprises: applying, based on the determining, a coding tool during an intra prediction process during which an intra prediction mode for the current block is determined. The method also comprises: performing the conversion based on the intra prediction mode. The method in accordance with the second aspect of the present disclosure applies the coding tool based on a determination whether an extended angular mode is used for the current block, which makes the coding tool may be applied more reasonable and the coding efficiency is improved thereby.

In a third aspect, another method of processing video data is proposed. The method comprises: performing a process on a current block of a video based on a template of the current block, the process being one of the following: a refining process, a process of filtering reference samples, or a process of determining a sample locating at a fractional position. The method further comprises: performing a conversion between the current block and a bitstream of the video. The method in accordance with the third aspect of the present disclosure performs the refining process based on a template of the current block, which makes that the refining process is performed on demand.

In a fourth aspect, another method of processing video data is proposed. The method comprises: determining a first intra prediction mode for a first block of a video. The method further comprises: determining, based on the first intra prediction mode, a second intra prediction mode for a second block of the video, comprising one of the following: excluding the first intra prediction mode during determining the second intra prediction mode for the second block if the first and second block are in a same video; or including the first intra prediction mode during determining the second intra prediction mode for the second block if the first and second block are in a different video. The method also comprises: performing a conversion between the first and second blocks and a bitstream of the video based on the first and second intra prediction modes. The method in accordance with the fourth aspect of the present disclosure utilizes the derived intra prediction mode for a first block to derive a further intra prediction mode of for a second block, which makes the determination of the further intra prediction mode is more reasonable and the coding efficiency is improved thereby.

In a fifth aspect, apparatus for processing video data is proposed. The apparatus comprises a processor and a non-transitory memory with instructions thereon, wherein the instructions upon execution by the processor, cause the processor to perform a method in accordance with the first, second, third or fourth aspect of the present disclosure.

In a sixth aspect, a non-transitory computer-readable recording medium is proposed. The non-transitory computer-readable storage medium stores instructions that cause a processor to perform a method in accordance with the first, second, third or fourth aspect of the present disclosure.

In a seventh aspect, a non-transitory computer-readable recording medium is proposed. The non-transitory computer-readable recording medium stores a bitstream of a video which is generated by a method performed by a video processing apparatus, wherein the method comprises: performing an intra prediction for a current block of a video based on at least one first parameter different from at least one second parameter used for an intra prediction of a normal angular mode, the current block being used with at least one extended angular mode; and generating the bitstream based on the performing.

In an eighth aspect, a non-transitory computer-readable recording medium is proposed. The non-transitory computer-readable recording medium stores a bitstream of a video which is generated by a method performed by a video processing apparatus, wherein the method comprises: determining whether an extended angular mode is used for a current block of the video; applying, based on the determining, a coding tool during an intra prediction process during which an intra prediction mode for the current block is determined; and generating the bitstream based on the determining and applying.

In a ninth aspect, a non-transitory computer-readable recording medium is proposed. The non-transitory computer-readable recording medium stores a bitstream of a video which is generated by a method performed by a video processing apparatus, wherein the method comprises: performing a process on a current block of the video based on a template of the current block, the process being one of the following: a refining process, a process of filtering reference samples, or a process of determining a sample locating at a fractional position; and generating the bitstream based on the performing.

In a tenth aspect, a non-transitory computer-readable recording medium is proposed. The non-transitory computer-readable recording medium stores a bitstream of a video which is generated by a method performed by a video processing apparatus, wherein the method comprises: determining a first intra prediction mode for a first block of the video; determining, based on the first intra prediction mode, a second intra prediction mode for a second block of the video, comprising one of the following: excluding the first intra prediction mode during determining the second intra prediction mode for the second block if the first and second block are in a same video; or including the first intra prediction mode during determining the second intra prediction mode for the second block if the first and second block are in a different video; and generating the bitstream based on the determining.

In an eleventh aspect, a method for storing bitstream of a video is proposed. The method comprises: performing an intra prediction for a current block of a video based on at least one first parameter different from at least one second parameter used for an intra prediction of a normal angular mode, the current block being used with at least one extended angular mode; generating the bitstream based on the performing; and storing the bitstream in a non-transitory computer-readable recording medium.

In a twelfth aspect, a method for storing bitstream of a video is proposed. The method comprises: determining whether an extended angular mode is used for a current block of the video; applying, based on the determining, a coding tool during an intra prediction process during which an intra prediction mode for the current block is determined; generating the bitstream based on the determining and applying; and storing the bitstream in a non-transitory computer-readable recording medium.

In a thirteenth aspect, a method for storing bitstream of a video is proposed. The method comprises: performing a process on a current block of the video based on a template of the current block, the process being one of the following: a refining process, a process of filtering reference samples, or a process of determining a sample locating at a fractional position; generating the bitstream based on the performing; and storing the bitstream in a non-transitory computer-readable recording medium.

In a fourteenth aspect, another method for storing bitstream of a video is proposed. The method comprises: determining a first intra prediction mode for a first block of the video; determining, based on the first intra prediction mode, a second intra prediction mode for a second block of the video, comprising one of the following: excluding the first intra prediction mode during determining the second intra prediction mode for the second block if the first and second block are in a same video; or including the first intra prediction mode during determining the second intra prediction mode for the second block if the first and second block are in a different video; generating the bitstream based on the determining; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram of an example video coding system in accordance with some embodiments of the present disclosure;

FIG. 2 illustrates a block diagram of an example video encoder in accordance with some embodiments of the present disclosure;

FIG. 3 illustrates a block diagram of an example video decoder in accordance with some embodiments of the present disclosure;

FIG. 4 illustrates a schematic diagram of intra prediction modes:

FIG. 5 illustrates a schematic diagram of reference samples for wide-angular intra prediction;

FIG. 6 illustrates a schematic diagram of a wide-angle intra prediction;

FIG. 7 illustrates a schematic diagram of locations of the samples;

FIG. 8A illustrates a schematic diagram of a definition of samples used by PDPC applied to diagonal and adjacent angular intra modes (a diagonal top-right mod);

FIG. 8B illustrates a schematic diagram of a definition of samples used by PDPC applied to diagonal and adjacent angular intra modes (a diagonal bottom-left mod);

FIG. 8C illustrates a schematic diagram of a definition of samples used by PDPC applied to diagonal and adjacent angular intra modes (an adjacent diagonal top-right mod);

FIG. 8D illustrates a schematic diagram of a definition of samples used by PDPC applied to diagonal and adjacent angular intra modes (an adjacent diagonal bottom-left mode);

FIG. 9 illustrates a schematic diagram of an example of four reference lines neighbouring to a prediction block;

FIG. 10A illustrates a schematic diagram of a process of sub-partition depending on the block size;

FIG. 10B illustrates a schematic diagram of a process of sub-partition depending on the block size;

FIG. 11 illustrates a schematic diagram of a matrix weighted intra prediction process;

FIG. 12 illustrates a schematic diagram of target samples, template samples and the reference samples of template;

FIG. 13 illustrates a schematic diagram of a set of chosen pixels on which a gradient analysis is performed;

FIG. 14 illustrates a schematic diagram of a convolution of a 3×3 Sobel gradient filter with the template;

FIG. 15 illustrates a schematic diagram of Intra prediction directions (informative);

FIG. 16 illustrates a schematic diagram of conventional angular IPMs and extended angular IPMs;

FIG. 17 illustrates a flowchart of method for video processing in accordance with some embodiments of the present disclosure;

FIG. 18 illustrates a flowchart of another method for video processing in accordance with some embodiments of the present disclosure;

FIG. 19 illustrates a flowchart of another method for video processing in accordance with some embodiments of the present disclosure;

FIG. 20 illustrates a flowchart of another method for video processing in accordance with some embodiments of the present disclosure;

FIG. 21 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

### Example Environment

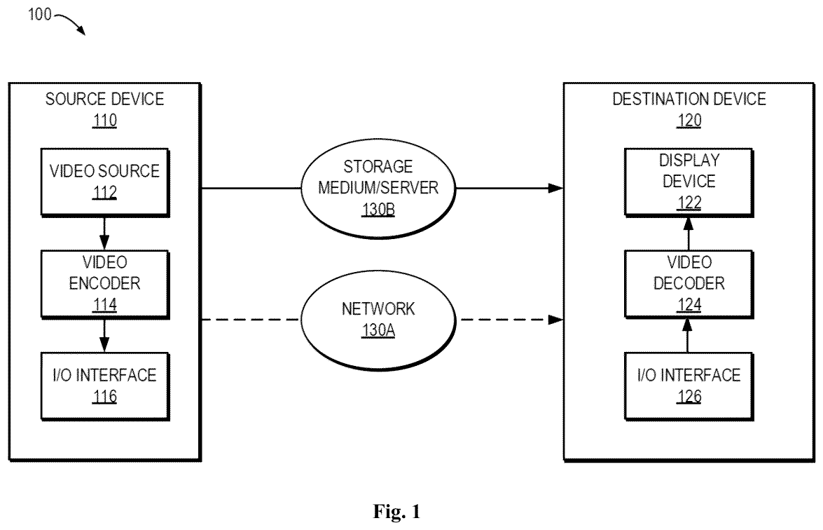

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

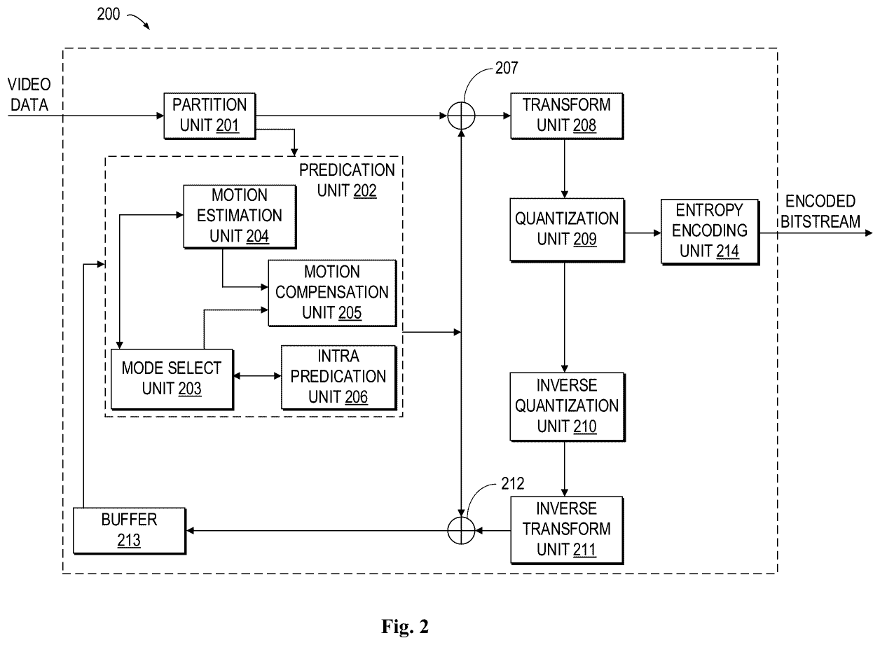

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

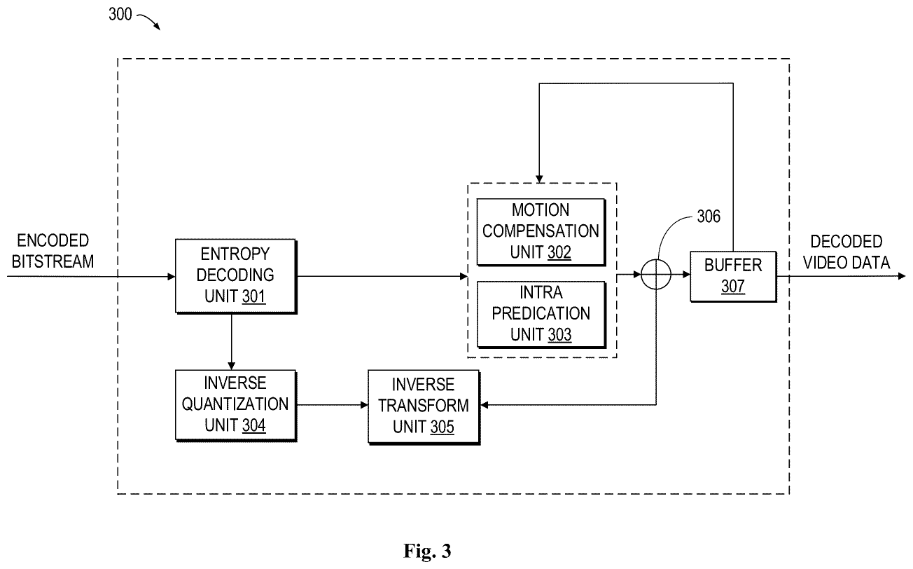

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307.

The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This invention is related to video coding technologies. Specifically, it is related angular prediction modes with denser direction, and a coding tool that derives intra prediction mode using previously decoded blocks and other coding tools in image/video coding. It may be applied to the existing video coding standard like HEVC, or the recently finalized standard (Versatile Video Coding). It may be also applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1. Coding Flow of a Typical Video Codec

An example of encoder block diagram of VVC contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

### 2.2. Intra Mode Coding With 67 Intra Prediction Modes

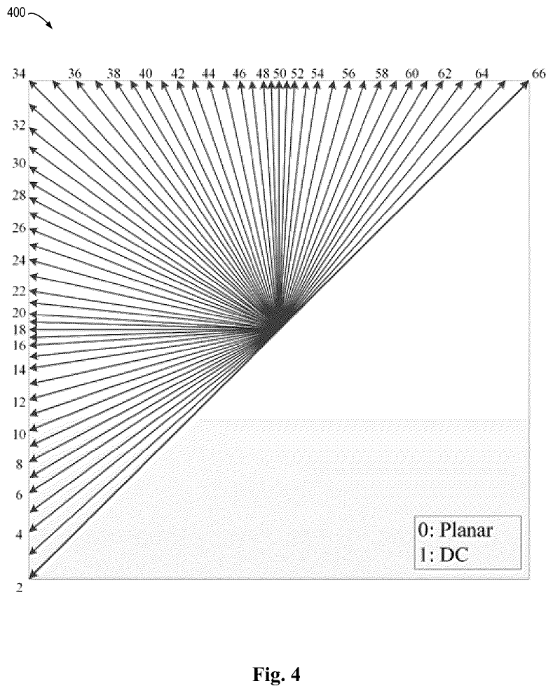

To capture the arbitrary edge directions presented in natural video, the number of directional intra modes is extended from 33, as used in HEVC, to 65, as shown in FIG. 4, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.2.1. Wide Angle Intra Prediction

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

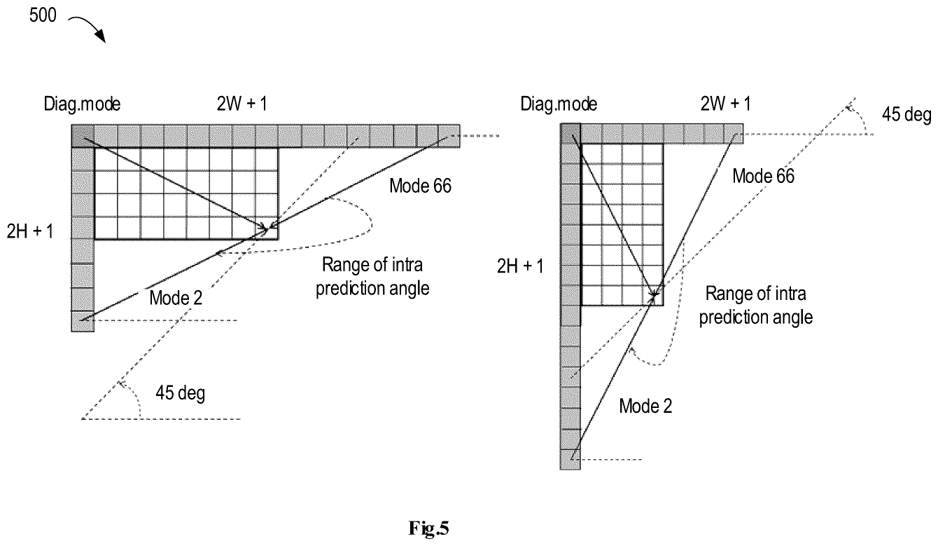

To support these prediction directions, the top reference with length 2W+1, and the left reference with length 2H+1, are defined as shown in FIG. 5.

The number of replaced modes in wide-angular direction mode depends on the aspect ratio of a block. The replaced intra prediction modes are illustrated in Table 2-1

TABLE 2-1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

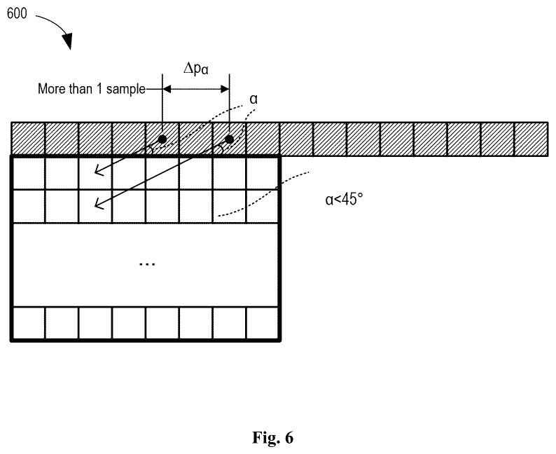

As shown in FIG. 6, two vertically adjacent predicted samples may use two non-adjacent reference samples in the case of wide-angle intra prediction (which illustrates a problem of discontinuity in case of directions beyond 45). Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.3. Inter prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.4. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.5. Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

pred_{C}(i, j)=α·rec_{L}′(i, j)+β (2-1)

where pred_{c}(i,j) represents the predicted chroma samples in a CU and rec_{L}(i,j) represents the down-sampled reconstructed luma samples of the same CU.

The CCLM parameters (a and B) are derived with at most four neighbouring chroma samples and their corresponding down-sampled luma samples. Suppose the current chroma block dimensions are W×H, then W″ and H′ are set as
W′=W, H′=H when LM mode is applied;
W′=W+H when LM-T mode is applied;
H′=H+W when LM-L mode is applied;

The above neighbouring positions are denoted as S[0, −1] . . . S[W′−1, −1] and the left neighbouring positions are denoted as S[−1, 0] . . . S[−1, H′−1]. Then the four samples are selected as
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM-T mode is applied or only the above neighbouring samples are available;
S[−1, H′/8], S[−1, 3*H′/8], S[−1, 5*H′/8], S[−1, 7*H′/8] when LM-L mode is applied or only the left neighbouring samples are available;

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

Xₐ=(x⁰_{A}+x¹_{A}+1)>>1; X_{b}=(x⁰_{B}+x¹_{B}+1)>1; Yₐ=(y⁰_{A}+y¹_{A}+1)>>1; Y_{b}=(y⁰_{B}+y¹_{B}+1)>>1 (2-2)

Finally, the linear model parameters α and β are obtained according to the following equations.

$$α = \frac{{Y}_{a} - {Y}_{b}}{{X}_{a} - {X}_{b}} \qquad ( 2 ‐ 3 )$$

$$β = {Y}_{b} - α \cdot {X}_{b} \qquad ( 2 ‐ 4 )$$

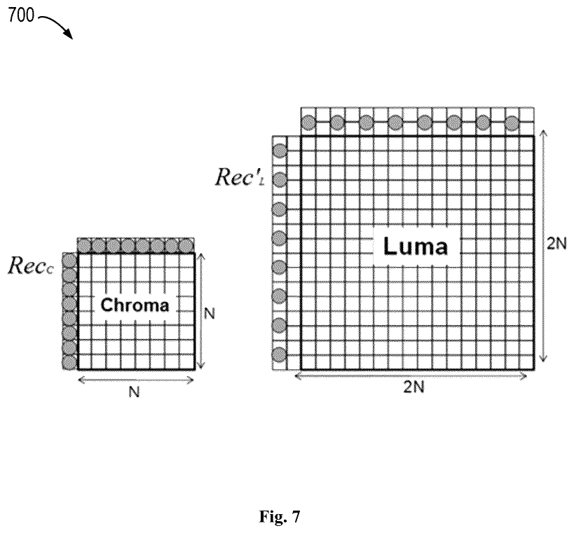

FIG. 7 shows an example of the location of the left and above samples and the sample of the current block involved in the CCLM mode and shows locations of the samples used for the derivation of a and B.

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

DivTable[ ]={0, 7, 6, 5, 5, 4, 4, 3, 3, 2, 2, 1, 1, 1, 1, 0} (2-5)

This would have a benefit of both reducing the complexity of the calculation as well as the memory size required for storing the needed tables.

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_T, and LM_L modes.

In LM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In LM mode, left and above templates are used to calculate the linear model coefficients. To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ \begin{matrix}{rec}_{L} ( 2 i - 1 , 2 j - 1 ) + 2 \cdot {rec}_{L} ( 2 i - 1 , 2 j - 1 ) + {rec}_{L} ( 2 i + 1 , 2 j - 1 ) + \\ {rec}_{L} ( 2 i - 1 , 2 j ) + 2 \cdot {rec}_{L} ( 2 i , 2 j ) + {rec}_{L} ( 2 i + 1 , 2 j ) + 4\end{matrix} ] ≫ 3$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) \\ + {rec}_{L} ( 2 i + 1 , 2 j ) + {rec}_{L} ( 2 i , 2 j + 1 ) + 4\end{matrix} ] ≫ 3$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the a and B values to the decoder.

For chroma intra mode coding, a total of 8 intra modes are allowed for chroma intra mode coding. Those modes include five traditional intra modes and three cross-component linear model modes (LM, LM_T, and LM_L). Chroma mode signalling and derivation process are shown in Table 2-2. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 2-2
Derivation of chroma prediction mode
from luma mode when CCLM is enabled

| | Corresponding luma intra prediction mode | | | | |
|---|---|---|---|---|---|
| Chroma prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2-3.

TABLE 2-3
Unified binarization table for chroma prediction mode

| Value of intra_chroma_pred_mode | Bin string |
|---|---|
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2-3, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_T (1). For this case, when sps_cclm_enabled_flag is 0, the first bin of the binarization table for the corresponding intra chroma pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2-3 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node is allowed to use CCLM in the following way:
If the 32×32 chroma node is not split or partitioned QT split, all chroma CUs in the 32×32 node can use CCLM

If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### 2.6. Position Dependent Intra Prediction Combination

In VVC, the results of intra prediction of DC, planar and several angular modes are further modified by a position dependent intra prediction combination (PDPC) method. PDPC is an intra prediction method which invokes a combination of the boundary reference samples and HEVC style intra prediction with filtered boundary reference samples. PDPC is applied to the following intra modes without signalling: planar, DC, intra angles less than or equal to horizontal, and intra angles greater than or equal to vertical and less than or equal to 80. If the current block is BDPCM mode or MRL index is larger than 0, PDPC is not applied.

The prediction sample pred(x′y′) is predicted using an intra prediction mode (DC, planar, angular) and a linear combination of reference samples according to the Equation 2-8 as follows:

$$pred ( {x}^{′} , {y}^{′} ) = Clip ( 0 , ( 1 ≪ BitDepth ) - 1 , ( wL \times {R}_{- 1 , {y}^{′}} + wT \times {R}_{{x}^{′} , - 1} + ( 64 - wL - wT ) \times pred ( {x}^{′} , {y}^{′} ) + 32 ) ≫ 6 \qquad 2 ‐ 8$$

where R_{x,-1}, R_{-1,y} represent the reference samples located at the top and left boundaries of current sample (x, y), respectively.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical. For angular modes, if the current angular mode is HOR_IDX or VER_IDX, left or top reference samples is not used, respectively. The PDPC weights and scale factors are dependent on prediction modes and the block sizes. PDPC is applied to the block with both width and height greater than or equal to 4.

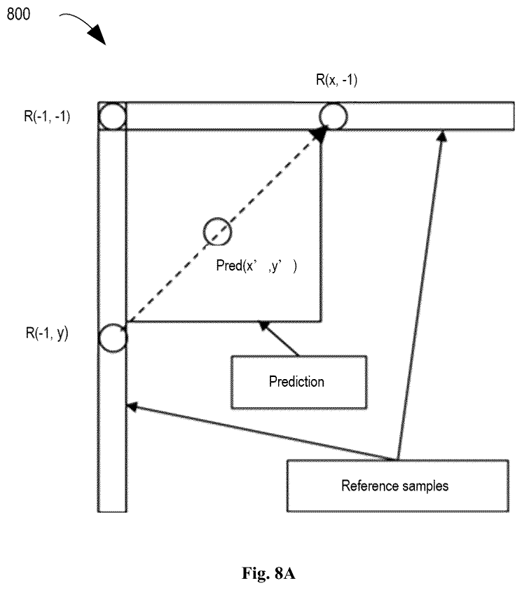

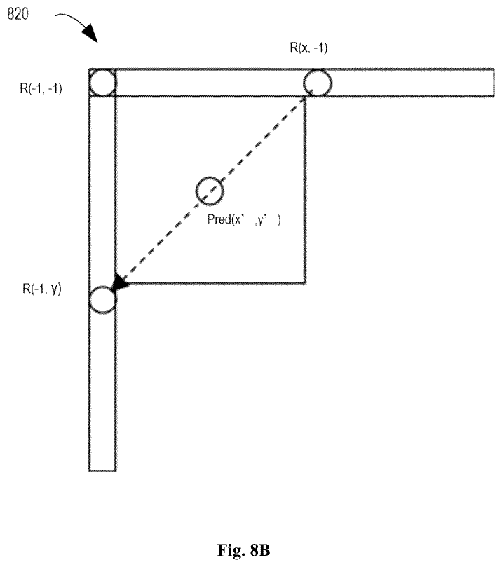

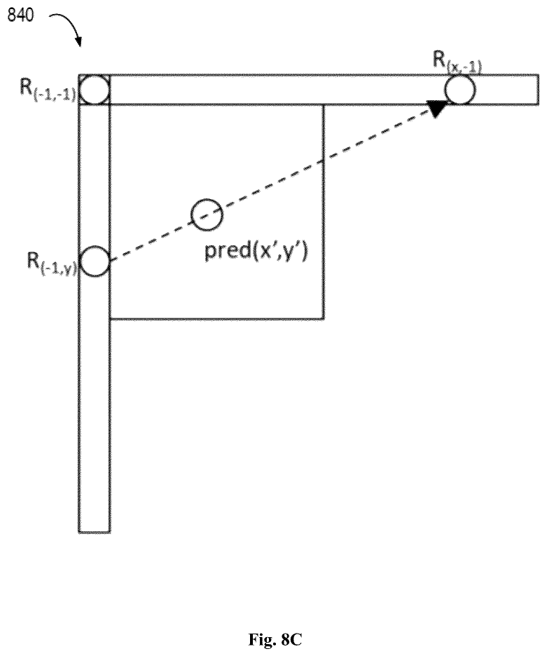

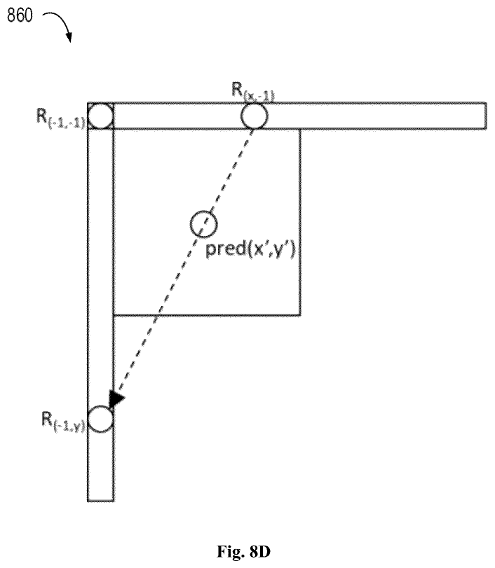

FIGS. 8A to 8D illustrate the definition of reference samples (R_{x,-1} and R_{-1,y}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other angular mode, the reference samples R_{x,-1} and R_{-1,y} could be located in fractional sample position. In this case, the sample value of the nearest integer sample location is used.

### 2.7. Multiple reference line (MRL) intra prediction

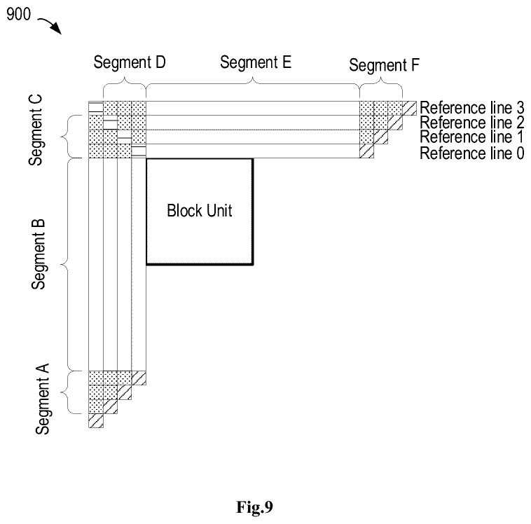

Multiple reference line (MRL) intra prediction uses more reference lines for intra prediction. In FIG. 9, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For reference line index, which is greater than 0, only include additional reference line modes in MPM list and only signal MPM index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighbouring luma reference lines for its down-sampling filters. The definition of MRL to use the same 3 lines is aligned as CCLM to reduce the storage requirements for decoders.

### 2.8. Intra Sub-Partitions (ISP)

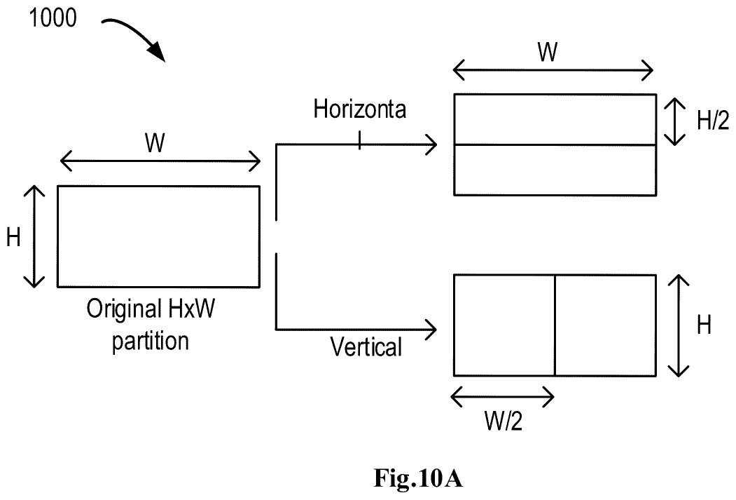

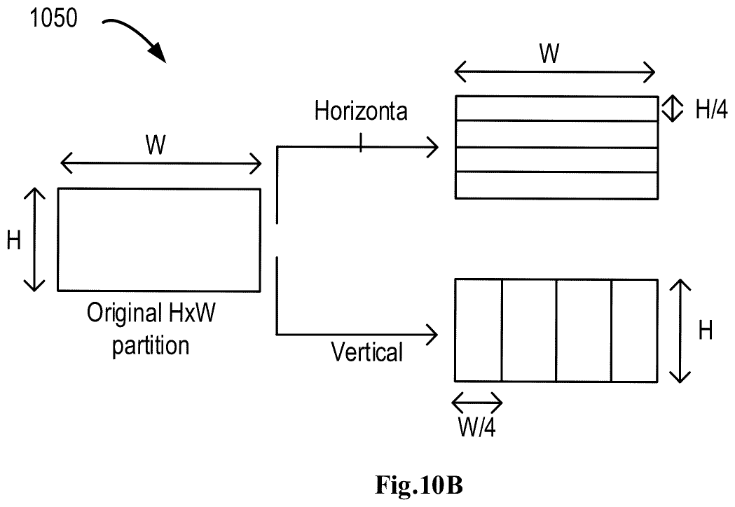

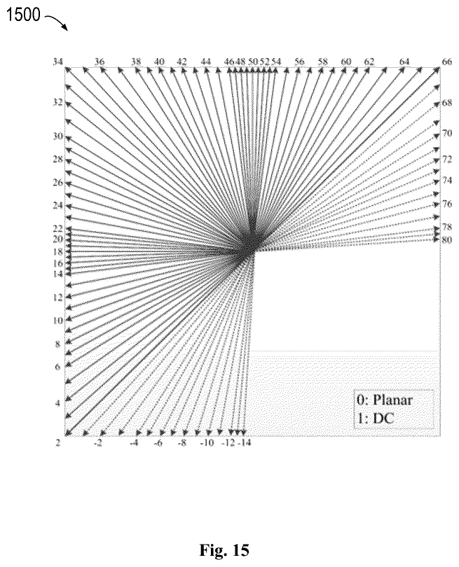

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding M/2×64 chroma TBs. If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIGS. 15A and 15B show examples of the two possibilities (wherein FIG. 10A illustrates a schematic diagram of a process of sub-partition depending on the block size (examples of sub-partitions for 4×8 and 8×4 CUs), and FIG. 10B illustrates a schematic diagram of a process of sub-partition depending on the block size (examples of sub-partitions for CUs other than 4□8, 8□4 and 4□4)). All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 2-4
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 2-4. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n×1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
If w=1 or h=1, then there is no horizontal or vertical transform respectively.
If w>4 and w≤16, t_{H}=DST-VII, otherwise, t_{H}=DCT-II
If h≥4 and h≤16, t_{V}=DST-VII, otherwise, t_{V}=DCT-II

In ISP mode, all 67 intra prediction modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### 2.9. Matrix Weighted Intra Prediction (MIP)

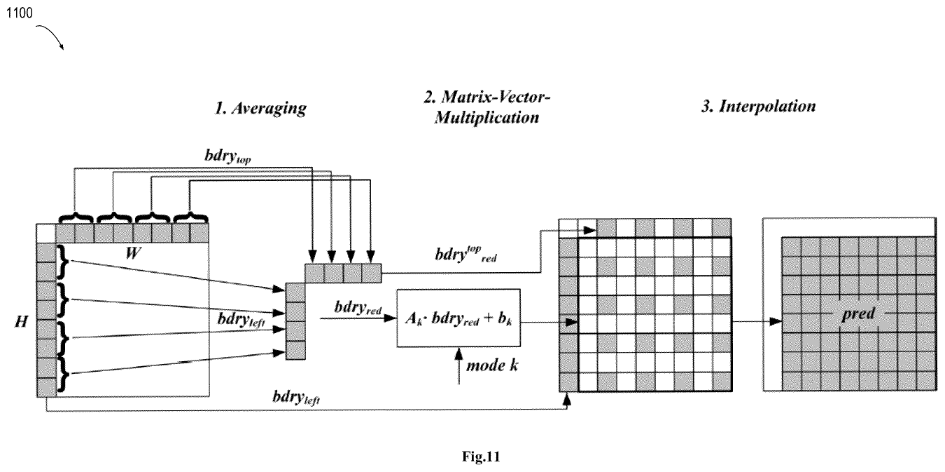

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 11.

### 2.9.1. Averaging Neighbouring Samples

Among the boundary samples, four samples or eight samples are selected by averaging based on block size and shape. Specifically, the input boundaries bdry^{top} and bdry^{left} are reduced to smaller boundaries bdry_{red}^{top} and bdry_{red}^{left} by averaging neighbouring boundary samples according to predefined rule depends on block size. Then, the two reduced boundaries bdry_{red}^{top} and bdry_{red}^{left} are concatenated to a reduced boundary vector bdry_{red} which is thus of size four for blocks of shape 4×4 and of size eight for blocks of all other shapes. If mode refers to the MIP-mode, this concatenation is defined as follows:

$$b d r {y}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{left} , {bdry}_{red}^{left} ] & for max ( W , H ) > 8 and mode < 6 \\ [ {bdry}_{red}^{left} , {bdry}_{red}^{top} ] & for max ( W , h ) > 8 and mode \geq 6\end{matrix} .$$

### 2.9.2. Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the down-sampled block of width W_{red} and height H_{red} is generated. Here, W_{red} and H_{red} are defined as:

$${W}_{red} = \{ \begin{matrix}4 & for max ( W , H ) \leq 8 \\ min ( W , 8 ) & for max ( W , H ) > 8\end{matrix}$$

$${H}_{red} = \{ \begin{matrix}4 & for max ( W , H ) \leq 8 \\ min ( H , 8 ) & for max ( W , H ) > 8\end{matrix}$$

The reduced prediction signal pred_{red} is computed by calculating a matrix vector product and adding an offset:

pred_{red}=A·bdry_{red}+b. (2-12)

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W,H) as follows:

$$i d x ( W , H ) = \{ \begin{matrix}0 for W = H = 4 \\ 1 for max ( W , H ) = 8 \\ 2 for max ( W , H ) > 8 .\end{matrix} \qquad ( 2 ‐ 13 )$$

Here, each coefficient of the matrix A is represented with 8 bits precision. The set S₀ consists of 16 matrices A₀ⁱ, i ∈ {0, . . . , 15} each of which has 16 rows and 4 columns and 16 offset vectors b₀ⁱ, i ∈ {0, . . . , 16} each of size 16. Matrices and offset vectors of that set are used for blocks of size 4×4. The set S1 consists of 8 matrices A₁ⁱ, i ∈ {0, . . . , 7}, each of which has 16 rows and 8 columns and 8 offset vectors b₁ⁱ, i ∈ {0, . . . , 7} each of size 16. The set S₂ consists of 6 matrices A₂ⁱ, i ∈ {0, . . . , 5}, each of which has 64 rows and 8 columns and of 6 offset vectors b₂ⁱ, i ∈ {0, . . . , 5} of size 64.

### 2.9.3. Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

### 2.9.4. Signalling of MIP Mode and Harmonization With Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows:

isTransposed=predModeIntra&1

modeId=predModeIntra>>1 (2-14)

MIP coding mode is harmonized with other coding tools by considering following aspects:
LFNST is enabled for MIP on large blocks. Here, the LFNST transforms of planar mode are used
The reference sample derivation for MIP is performed exactly as for the conventional intra prediction modes
For the up-sampling step used in the MIP-prediction, original reference samples are used instead of down-sampled ones
Clipping is performed before up-sampling and not after up-sampling
MIP is allowed up to 64×64 regardless of the maximum transform size

The number of MIP modes is 32 for sizeId=0, 16 for sizeId=1 and 12 for sizeId=2.

### 2.10. Decoder-Side Intra Mode Derivation

In one specific example embodiment, the solution of decoder-side intra mode derivation is described in JVET-C0061.

In JEM-2.0 intra modes are extended to 67 from 35 modes in HEVC, and they are derived at encoder and explicitly signalled to decoder. A significant amount of overhead is spent on intra mode coding in JEM-2.0. For example, the intra mode signalling overhead may be up to 5˜10% of overall bitrate in all intra coding configuration. This contribution proposes the decoder-side intra mode derivation approach to reduce the intra mode coding overhead while keeping prediction accuracy.

To reduce the overhead of intra mode signalling, this contribution presents a decoder-side intra mode derivation (DIMD) approach. In the proposed approach, instead of signalling intra mode explicitly, the information is derived at both encoder and decoder from the neighbouring reconstructed samples of current block. The intra mode derived by DIMD is used in two ways:
1) For 2N×2N CUs, the DIMD mode is used as the intra mode for intra prediction when the corresponding CU-level DIMD flag is turned on;
2) For N×N CUs, the DIMD mode is used to replace one candidate of the existing MPM list to improve the efficiency of intra mode coding.

### 2.10.1. Templated Based Intra Mode Derivation

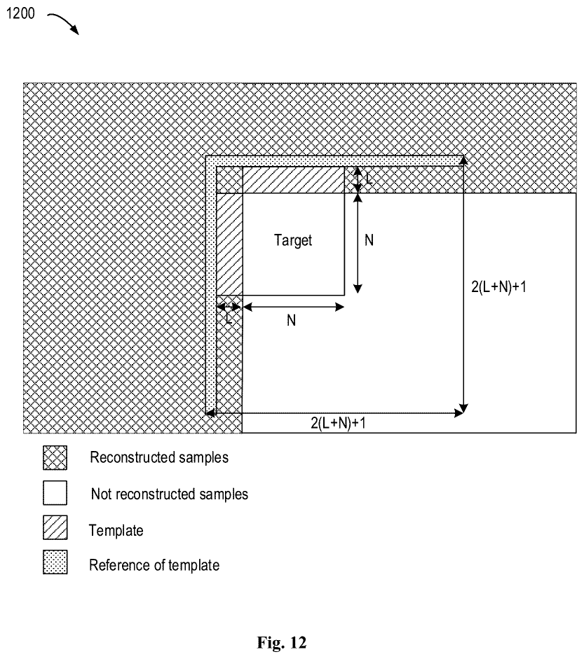

As illustrated in FIG. 12, the target denotes the current block (of block size N) for which intra prediction mode is to be estimated. The template (indicated by the patterned region in FIG. 12) specifies a set of already reconstructed samples, which are used to derive the intra mode. The template size is denoted as the number of samples within the template that extends to the above and the left of the target block, i.e., L. In the current implementation, a template size of 2 (i.e., L=2) is used for 4×4 and 8×8 blocks and a template size of 4 (i.e., L=4) is used for 16×16 and larger blocks. The reference of template (indicated by the dotted region in FIG. 12) refers to a set of neighbouring samples from above and left of the template, as defined by JEM-2.0. Unlike the template samples which are always from reconstructed region, the reference samples of template may not be reconstructed yet when encoding/decoding the target block. In this case, the existing reference samples substitution algorithm of JEM-2.0 is utilized to substitute the unavailable reference samples with the available reference samples.

For each intra prediction mode, the DIMD calculates the absolute difference (SAD) between the reconstructed template samples and its prediction samples obtained from the reference samples of the template. The intra prediction mode that yields the minimum SAD is selected as the final intra prediction mode of the target block.

### 2.10.2. DIMD for Intra 2N×2N CUs

For intra 2N×2N CUs, the DIMD is used as one additional intra mode, which is adaptively selected by comparing the DIMD intra mode with the optimal normal intra mode (i.e., being explicitly signalled). One flag is signalled for each intra 2N×2N CU to indicate the usage of the DIMD. If the flag is one, then the CU is predicted using the intra mode derived by DIMD; otherwise, the DIMD is not applied and the CU is predicted using the intra mode explicitly signalled in the bit-stream. When the DIMD is enabled, chroma components always reuse the same intra mode as that derived for luma component, i.e., DM mode.

Additionally, for each DIMD-coded CU, the blocks in the CU can adaptively select to derive their intra modes at either PU-level or TU-level. Specifically, when the DIMD flag is one, another CU-level DIMD control flag is signalled to indicate the level at which the DIMD is performed. If this flag is zero, it means that the DIMD is performed at the PU level and all the TUs in the PU use the same derived intra mode for their intra prediction; otherwise (i.e., the DIMD control flag is one), it means that the DIMD is performed at the TU level and each TU in the PU derives its own intra mode.

Further, when the DIMD is enabled, the number of angular directions increases to 129, and the DC and planar modes still remain the same. To accommodate the increased granularity of angular intra modes, the precision of intra interpolation filtering for DIMD-coded CUs increases from 1/32-pel to 1/64-pel. Additionally, in order to use the derived intra mode of a DIMD coded CU as MPM candidate for neighbouring intra blocks, those 129 directions of the DIMD-coded CUs are converted to “normal” intra modes (i.e., 65 angular intra directions) before they are used as MPM.

### 2.10.3. DIMD for Intra N×N CUs

In the proposed method, intra modes of intra N×N CUs are always signalled. However, to improve the efficiency of intra mode coding, the intra modes derived from DIMD are used as MPM candidates for predicting the intra modes of four PUs in the CU. In order to not increase the overhead of MPM index signalling, the DIMD candidate is always placed at the first place in the MPM list and the last existing MPM candidate is removed. Also, pruning operation is performed such that the DIMD candidate will not be added to the MPM list if it is redundant.

### 2.10.4. Intra Mode Search Algorithm of DIMD

In order to reduce encoding/decoding complexity, one straightforward fast intra mode search algorithm is used for DIMD. Firstly, one initial estimation process is performed to provide a good starting point for intra mode search. Specifically, an initial candidate list is created by selecting N fixed modes from the allowed intra modes. Then, the SAD is calculated for all the candidate intra modes and the one that minimizes the SAD is selected as the starting intra mode. To achieve a good complexity/performance trade-off, the initial candidate list consists of 11 intra modes, including DC, planar and every 4-th mode of the 33 angular intra directions as defined in HEVC, i.e., intra modes 0, 1, 2, 6, 10 . . . 30, 34.

If the starting intra mode is either DC or planar, it is used as the DIMD mode. Otherwise, based on the starting intra mode, one refinement process is then applied where the optimal intra mode is identified through one iterative search. It works by comparing at each iteration the SAD values for three intra modes separated by a given search interval and maintain the intra mode that minimize the SAD. The search interval is then reduced to half, and the selected intra mode from the last iteration will serve as the center intra mode for the current iteration. For the current DIMD implementation with 129 angular intra directions, up to 4 iterations are used in the refinement process to find the optimal DIMD intra mode.

### 2.11. CE3-Related: Decoder-side Intra Mode Derivation

In one specific example embodiment, the solution of decoder-side intra mode derivation is described in JVET-L0164.

In this contribution, a method is proposed to avoid transmitting the luma intra prediction mode in the bitstream. This is done by deriving the luma intra mode using previously encoded/decoded pixels, in an identical fashion at the encoder and at the decoder. This process defines a new coding mode called DIMD, whose selection is signalled in the bitstream for intra coded blocks using a simple flag. DIMD competes with other coding modes at the encoder, including the classical Intra coding mode (where the intra prediction mode is coded). Note that in this contribution, DIMD only applies to luma. For chroma, classical intra coding mode applies. As done for other coding modes (classical intra, inter, merge, etc.), a rate-distortion cost is computed for the DIMD mode, and is then compared to the coding costs of other modes to decide whether to select it as final coding mode for a current block.

At the decoder side, the DIMD flag is first parsed. If it is true, the intra prediction mode is derived in the reconstruction process using the same previously encoded neighbouring pixels. If not, the intra prediction mode is parsed from the bitstream as in classical intra coding mode.

### 2.11.1. Intra Prediction Mode Derivation

### 2.11.1.1. Gradient Analysis

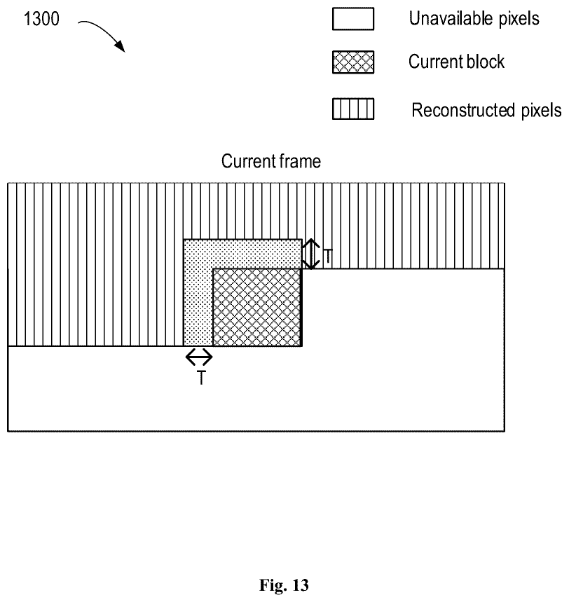

To derive the intra prediction mode for a block, a set of neighbouring pixels are first selected on which a gradient analysis is performed. For normativity purposes, these pixels should be in the decoded/reconstructed pool of pixels. As shown in FIG. 13, a template surrounding the current block is chosen by T pixels to the left, and T pixels above. T=2 is set in the proposal. Next, a gradient analysis is performed on the pixels of the template. This allows to determine a main angular direction for the template, which it is assumed (and that is the core premise of our method) has a high chance to be identical to the one of the current block. Thus, a simple 3×3 Sobel gradient filter is used, defined by the following matrices that will be convoluted with the template:

$${M}_{x} = [ \begin{matrix}- 1 & 0 & 1 \\ - 2 & 0 & 2 \\ = 1 & 0 & 1\end{matrix} ] and {M}_{y} = [ \begin{matrix}- 1 & - 2 & - 1 \\ 0 & 0 & 0 \\ 1 & 2 & 1\end{matrix} ] \qquad ( 2 ‐ 15 )$$

For each pixel of the template, each of these two matrices with the 3×3 window centered around the current pixel is point-by-point multiplied and composed of its 8 direct neighbors, and the result is summed. Thus, two values Gₓ (from the multiplication with Mₓ), and G_{y} (from the multiplication with M_{y}) corresponding to the gradient at the current pixel are obtained, in the horizontal and vertical direction respectively.

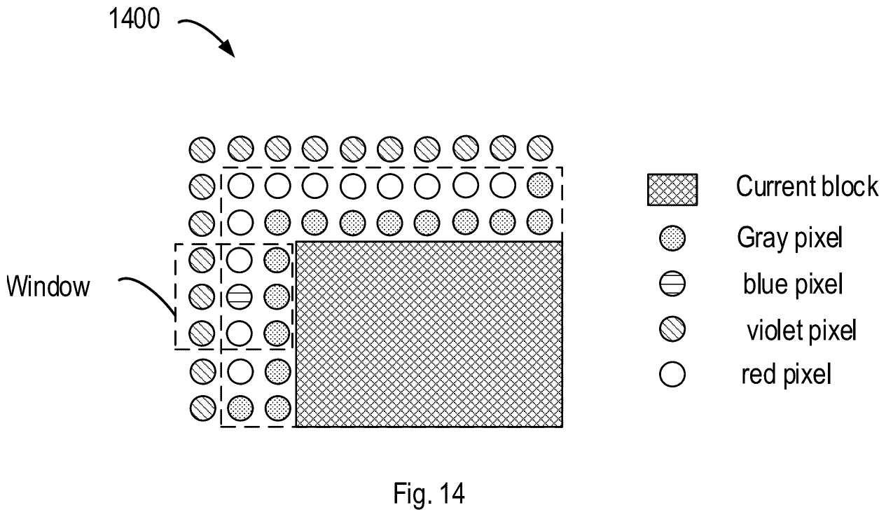

FIG. 14 shows the convolution process (where a convolution of a 3×3 Sobel gradient filter with the template is illustrated). The blue pixel is the current pixel. Red pixels (including the blue) are pixels on which the gradient analysis is possible. Gray pixels are pixels on which the gradient analysis is not possible due to lack of some neighbors. Violet pixels are available (reconstructed) pixels outside of the considered template, used in the gradient analysis of the red pixels. In case a violet pixel is not available (due to blocks being too close to the border of the picture for instance), the gradient analysis of all red pixels that use this violet pixel is not performed.

### 2.11.1.2. Histogram of Gradients and Mode Derivation

For each red pixel, the intensity (G) and the orientation (O) of the gradient using Gₓ and G_{y} are calculated as such:

$$G = \vert {G}_{x} \vert + \vert {G}_{y} \vert and O = atan ( \frac{{G}_{y}}{{G}_{x}} ) \qquad ( 2 ‐ 16 )$$

Note that a fast implementation of the a tan function is proposed. The orientation of the gradient is then converted into an intra angular prediction mode, used to index a histogram (first initialized to zero). The histogram value at that intra angular mode is increased by G. Once all the red pixels in the template have been processed, the histogram will contain cumulative values of gradient intensities, for each intra angular mode. The mode that shows the highest peak in the histogram is selected as intra prediction mode for the current block. If the maximum value in the histogram is 0 (meaning no gradient analysis was able to be made, or the area composing the template is flat), then the DC mode is selected as intra prediction mode for the current block.

For blocks that are located at the top of CTUs, the gradient analysis of the pixels located in the top part of the template is not performed. The DIMD flag is coded using three possible contexts, depending on the left and above neighbouring blocks, similarly to the Skip flag coding. Context 0 corresponds to the case where none of the left and above neighbouring blocks are coded with DIMD mode, context 1 corresponds to the case where only one neighbouring block is coded with DIMD, and context 2 corresponds to the case where both neighbors are DIMD-coded. Initial symbol probabilities for each context are set to 0.5.

2.11.2. Prediction with 130 intra modes

One advantage that DIMD offers over classical intra mode coding is that the derived intra mode can have a higher precision, allowing more precise predictions at no additional cost since it is not transmitted in the bitstream. The derived intra mode spans 129 angular modes, hence a total of 130 modes including DC (the derived intra mode can never be planar in our contribution). The classical intra coding mode is unchanged, i.e., the prediction and mode coding still use 67 modes.

The required changes to Wide Angle Intra Prediction and simplified PDPC were performed to accommodate for prediction using 129 modes. Note that only the prediction process uses the extended intra modes, meaning that for any other purpose (deciding whether to filter the reference samples for instance), the mode is converted back to 67-mode precision.

2.11.3. Other normative changes

In the DIMD mode, the luma intra mode is derived during the reconstruction process, just prior to the block reconstruction. This is done to avoid a dependency on reconstructed pixels during parsing. However, by doing so, the luma intra mode of the block will be undefined for the chroma component of the block, and for the luma component of neighbouring blocks. This causes an issue because:
For chroma, a fixed mode candidate list is defined. Usually, if the luma mode equals one of the chroma candidates, that candidate will be replaced with the vertical diagonal (VDIA_IDX) intra mode. Since in DIMD, the luma mode is unavailable, the initial chroma mode candidate list is not modified.

In classical intra mode, where the luma intra prediction mode is to be parsed from the bitstream, an MPM list is constructed using the luma intra modes of neighbouring blocks, which can be unavailable if those blocks were coded using DIMD. In this case, in our contribution, DIMD-coded blocks are treated as inter blocks during MPM list construction, meaning they are effectively considered unavailable.

### 2.12. Specification of Intra Prediction for Angular Intra Prediction Modes

In one specific example embodiment, the solution of intra prediction for angular intra prediction modes is described in VVC specification JVET-T2001-v2.

### 8.4.5.2.14 Specification of INTRA_ANGULAR2 . . . INTRA_ANGULAR66 Intra Prediction Modes

Inputs to this process are:
the intra prediction mode predModeIntra.
a variable refIdx specifying the intra prediction reference line index.
a variable nTbW specifying the transform block width.
a variable nTbH specifying the transform block height.
a variable refW specifying the reference samples width.
a variable refH specifying the reference samples height.
a variable nCbW specifying the coding block width.
a variable nCbH specifying the coding block height.
a variable refFilterFlag specifying the value of reference filter flag,
a variable cIdx specifying the colour component of the current block,
the neighbouring samples p[x][y], with x=−1−refIdx, y=−1−refIdx . . . refH−1 and x=−refIdx . . . refW−1, y=−1−refIdx.

Outputs of this process are the predicted samples predSamples[x][y], with x=0 . . . nTbW−1, y=0 . . . nTbH−1.

The variable nTbS is set equal to (Log2(nTbW)+Log2(nTbH))>>1.

The variable filterFlag is derived as follows:
If one or more of the following conditions are true, filterFlag is set equal to 0:
   refFilterFlag is equal to 1;
   refIdx is not equal to 0;
   IntraSubPartitionsSplitType is not equal to ISP_NO_SPLIT.
Otherwise, the following applies:
   The variable minDistVerHor is set equal to Min(Abs(predModeIntra−50), Abs(predModeIntra−18)).
   The variable intraHorVerDistThres[nTbS] is specified in Table 23.
   The variable filterFlag is derived as follows:
      If minDistVerHor is greater than intraHorVerDistThres[nTbS], filterFlag is set equal to 1.
      Otherwise, filterFlag is set equal to 0.

TABLE 23
Specification of intraHorVerDistThres[nTbS] for various transform block sizes nTbS

| | nTbS = 2 | nTbS = 3 | nTbS = 4 | nTbS = 5 | nTbS = 6 |
|---|---|---|---|---|---|
| intraHorVerDistThres[nTbS] | 24 | 14 | 2 | 0 | 0 |

FIG. 15 illustrates the 93 prediction directions, where the dashed directions are associated with the wide-angle modes that are only applied to non-square blocks.

Table 24 specifies the mapping table between predModeIntra and the angle parameter intraPredAngle.

TABLE 24
Specification of intraPredAngle

| predModeIntra | −14 | −13 | −12 | −11 | −10 | −9 | −8 | −7 | −6 | −5 | −4 | −3 | −2 | −1 | 2 | 3 | 4 |
|---|---|---|---|---|---|---|---|---|---|---|---|---|---|---|---|---|---|
| intraPredAngle | 512 | 341 | 256 | 171 | 128 | 102 | 86 | 73 | 64 | 57 | 51 | 45 | 39 | 35 | 32 | 29 | 26 |

| predModeIntra | 5 | 6 | 7 | 8 | 9 | 10 | 11 | 12 | 13 | 14 | 15 | 16 | 17 | 18 | 19 | 20 | 21 |
|---|---|---|---|---|---|---|---|---|---|---|---|---|---|---|---|---|---|
| intraPredAngle | 23 | 20 | 18 | 16 | 14 | 12 | 10 | 8 | 6 | 4 | 3 | 2 | 1 | 0 | −1 | −2 | −3 |

| predModeIntra | 22 | 23 | 24 | 25 | 26 | 27 | 28 | 29 | 30 | 31 | 32 | 33 | 34 | 35 | 36 | 37 | 38 |
|---|---|---|---|---|---|---|---|---|---|---|---|---|---|---|---|---|---|
| intraPredAngle | −4 | −6 | −8 | −10 | −12 | −14 | −16 | −18 | −20 | −23 | −26 | −29 | −32 | −29 | −26 | −23 | −20 |

| predModeIntra | 39 | 40 | 41 | 42 | 43 | 44 | 45 | 46 | 47 | 48 | 49 | 50 | 51 | 52 | 53 | 54 | 55 |
|---|---|---|---|---|---|---|---|---|---|---|---|---|---|---|---|---|---|
| intraPredAngle | −18 | −16 | −14 | −12 | −10 | −8 | −6 | −4 | −3 | −2 | −1 | 0 | 1 | 2 | 3 | 4 | 6 |

| predModeIntra | 56 | 57 | 58 | 59 | 60 | 61 | 62 | 63 | 64 | 65 | 66 | 67 | 68 | 69 | 70 | 71 | 72 |
|---|---|---|---|---|---|---|---|---|---|---|---|---|---|---|---|---|---|
| intraPredAngle | 8 | 10 | 12 | 14 | 16 | 18 | 20 | 23 | 26 | 29 | 32 | 35 | 39 | 45 | 51 | 57 | 64 |

| predModeIntra | 73 | 74 | 75 | 76 | 77 | 78 | 79 | 80 |
|---|---|---|---|---|---|---|---|---|
| intraPredAngle | 73 | 86 | 102 | 128 | 171 | 256 | 341 | 512 |

When intraPredAngle is not equal to 0. the inverse angle parameter invAngle is derived based on intraPredAngle as follows:

$$invAngle = Round ( \frac{512 * 32}{intraPredAngle} ) \qquad ( 328 )$$

The interpolation filter coefficients fC[phase][j] and fG[phase][j] with phase=0 . . . 31 and j=0 . . . 3 are specified in Table 25.

TABLE 25
Specification of interpolation filter coefficients fC and fG sample

| Fractional | | | | | | | | |
|---|---|---|---|---|---|---|---|---|
| sample | fC interpolation filter coefficients | | | | fG interpolation filter coefficients | | | |
| position p | f_{C}[p][0] | f_{C}[p][1] | f_{C}[p][2] | f_{C}[p][3] | fG[p][0] | fG[p][1] | fG[p][2] | fG[p][3] |
| 0 | 0 | 64 | 0 | 0 | 16 | 32 | 16 | 0 |
| 1 | −1 | 63 | 2 | 0 | 16 | 32 | 16 | 0 |
| 2 | −2 | 62 | 4 | 0 | 15 | 31 | 17 | 1 |
| 3 | −2 | 60 | 7 | −1 | 15 | 31 | 17 | 1 |
| 4 | −2 | 58 | 10 | −2 | 14 | 30 | 18 | 2 |
| 5 | −3 | 57 | 12 | −2 | 14 | 30 | 18 | 2 |
| 6 | −4 | 56 | 14 | −2 | 13 | 29 | 19 | 3 |
| 7 | −4 | 55 | 15 | −2 | 13 | 29 | 19 | 3 |
| 8 | −4 | 54 | 16 | −2 | 12 | 28 | 20 | 4 |
| 9 | −5 | 53 | 18 | −2 | 12 | 28 | 20 | 4 |
| 10 | −6 | 52 | 20 | −2 | 11 | 27 | 21 | 5 |
| 11 | −6 | 49 | 24 | −3 | 11 | 27 | 21 | 5 |
| 12 | −6 | 46 | 28 | −4 | 10 | 26 | 22 | 6 |
| 13 | −5 | 44 | 29 | −4 | 10 | 26 | 22 | 6 |
| 14 | −4 | 42 | 30 | −4 | 9 | 25 | 23 | 7 |
| 15 | −4 | 39 | 33 | −4 | 9 | 25 | 23 | 7 |
| 16 | −4 | 36 | 36 | −4 | 8 | 24 | 24 | 8 |
| 17 | −4 | 33 | 39 | −4 | 8 | 24 | 24 | 8 |
| 18 | −4 | 30 | 42 | −4 | 7 | 23 | 25 | 9 |
| 19 | −4 | 29 | 44 | −5 | 7 | 23 | 25 | 9 |
| 20 | −4 | 28 | 46 | −6 | 6 | 22 | 26 | 10 |
| 21 | −3 | 24 | 49 | −6 | 6 | 22 | 26 | 10 |
| 22 | −2 | 20 | 52 | −6 | 5 | 21 | 27 | 11 |
| 23 | −2 | 18 | 53 | −5 | 5 | 21 | 27 | 11 |
| 24 | −2 | 16 | 54 | −4 | 4 | 20 | 28 | 12 |
| 25 | −2 | 15 | 55 | −4 | 4 | 20 | 28 | 12 |
| 26 | −2 | 14 | 56 | −4 | 3 | 19 | 29 | 13 |
| 27 | −2 | 12 | 57 | −3 | 3 | 19 | 29 | 13 |
| 28 | −2 | 10 | 58 | −2 | 2 | 18 | 30 | 14 |
| 29 | −1 | 7 | 60 | −2 | 2 | 18 | 30 | 14 |
| 30 | 0 | 4 | 62 | −2 | 1 | 17 | 31 | 15 |
| 31 | 0 | 2 | 63 | −1 | 1 | 17 | 31 | 15 |

The values of the prediction samples predSamples[x][y], with x=0 . . . nTbW−1, y=0 . . . nTbH−1 are derived as follows:
If predModeIntra is greater than or equal to 34, the following ordered steps apply:
1. The reference sample array ref[x] is specified as follows:
The following applies:

$$ref [ x ] = p [ - 1 - refIdx + x ] [ - 1 - refIdx ] , with x = 0 … nTbW + refIdx + 1 \qquad ( 329 )$$

If intraPredAngle is less than 0, the main reference sample array is extended as follows:

$$ref [ x ] = p [ - 1 - refIdx ] [ - 1 - refIdx + Min ( ( x * invAngle + 256 ) ≫ 9 , nTbH ) ] , with x = - nTbH … - 1 \qquad ( 330 )$$

Otherwise, the following applies:

$$ref [ x ] = p [ - 1 - refIdx + x ] [ - 1 - refIdx ] , with x = nTbW + 2 + refIdx … refW + refIdx \qquad ( 331 )$$

The additional samples ref[refW+refIdx+x] with x=1 . . . (Max(1, nTbW/nTbH)*refIdx+1) are derived as follows:

$$ref [ refW + refIdx + x ] = p [ - 1 + refW ] [ - 1 - refIdx ] \qquad ( 332 )$$

2. The values of the prediction samples predSamples[x][y], with x=0 . . . nTbW−1, y=0 . . . nTbH−1 are derived as follows:
The index variable iIdx and the multiplication factor iFact are derived as follows:

iIdx=(((y+1+refIdx)*intraPredAngle)>>5)+refIdx (333)

iFact=((y+1+refIdx)*intraPredAngle)&31 (334)
If cIdx is equal to 0, the following applies:
The interpolation filter coefficients fT[j] with j=0 . . . 3 are derived as follows:

fT[j]=filterFlag?fG[iFact][j]:fC[iFact][j] (335)
The value of the prediction samples predSamples[x][y] is derived as follows:

predSamples[x][y]=Clip1(((Σᵢ₌₀³fT[i]*ref[x+iIdx+i])+32)>>6) (336)
Otherwise (cIdx is not equal to 0), depending on the value of iFact, the following applies:
If iFact is not equal to 0, the value of the prediction samples predSamples[x][y] is derived as follows:

$$predSamples [ x ] [ y ] = ( ( 32 - iFact ) * ref [ x + iIdx + 1 ] + iFact * ref [ x + iIdx + 2 ] + 16 ≫ 5 \qquad ( 337 )$$

Otherwise, the value of the prediction samples predSamples[x][y] is derived as follows:

predSamples[x][y]=ref[x+iIdx+1] (338)
Otherwise (predModeIntra is less than 34), the following ordered steps apply:
1. The reference sample array ref[x] is specified as follows:
   The following applies:

ref[x]=p[−1−refIdx][−1−refIdx+x], with x=0 . . . nTbH+refIdx+1 (339)
If intraPredAngle is less than 0, the main reference sample array is extended as follows:

$$ref [ x ] = p [ - 1 - refIdx + Min ( ( x * invAngle + 256 ) ≫ 9 , nTbW ) ] [ - 1 - refIdx ] , with x = - nTbW … - 1 \qquad ( 340 )$$

Otherwise, the following applies:

ref[x]=[−1−refIdx][−1−refIdx+x], with x=nTbH+2+refIdx . . . refH+refIdx (341)
The additional samples ref[ref+refIdx+x] with x=1. . . (Max(1, nTbH/nTbW)*reflex+1) are derived as follows:

$$ref [ refH + refIdx + x ] = p [ - 1 - refIdx ] [ - 1 + refH ] \qquad ( 342 )$$

2. The values of the prediction samples predSamples[x][y], with x=0 . . . nTbW−1, y=0 . . . nTbH−1 are derived as follows:
The index variable iIdx and the multiplication factor iFact are derived as follows:

iIdx=(((x+1+refIdx)*intraPredAngle)>>5)+refIdx (343)

iFact=((x+1+refIdx)*intraPredAngle)&31 (344)
If cIdx is equal to 0, the following applies:
The interpolation filter coefficients fT[j] with j=0 . . . 3 are derived as follows:

fT[j]=filterFlag?fG[iFact][j]:fC[iFact][j] (345)
The value of the prediction samples predSamples[x][y] is derived as follows:

predSamples[x][y]=Clip1(((Σᵢ₌₀³[i]+ref[y+iIdx+i])+32)>>6) (346)
Otherwise (cIdx is not equal to 0), depending on the value of iFact, the following applies:
If iFact is not equal to 0, the value of the prediction samples predSamples[x][y] is derived as follows:

$$predSamples [ x ] [ y ] = ( ( 32 - iFact ) * ref [ y + iIdx + 1 ] + iFact * ref [ y + iIdx + 2 ] + 16 ) ≫ 5 \qquad ( 347 )$$

Otherwise, the value of the prediction samples predSamples[x][y] is derived as follows:

predSamples[x][y]=ref[y+iIdx+1] (348)

### 3. PROBLEMS

1. In current design of intra prediction, angular intra prediction modes are used in the intra prediction to explore the directional information of current block. The coding gain could be achieved when denser angular intra prediction modes are used. However, the usage of denser angular modes (e.g., intra prediction angle, and/or interpolation filter) need to be further studied.
2. In current design, PDPC and gradient PDPC are always applied to current block when certain intra prediction modes are used, which could cause some coding loss when PDPC or gradient PDPC is not efficient for some blocks.
3. An intra prediction mode could be derived at the decoder, and how to use the derived intra prediction mode need to be further studied.

### 4. INVENTION

The detailed inventions below should be considered as examples to explain general concepts. These inventions should not be interpreted in a narrow way. Furthermore, these inventions can be combined in any manner.

In this disclosure, the denser/extended angular modes may denote those additional intra prediction modes (denoted by the red dash lines in FIG. 4-1) indicating denser directional information, which may locate between two adjacent existing intra prediction modes (e.g. those defined in H.266, and denoted by black line in FIG. 4-1), or beyond the angle ranges of the existing intra prediction modes.

In this disclosure, the term DIMD represents a coding tool that derives intra prediction mode using previously decoded blocks.

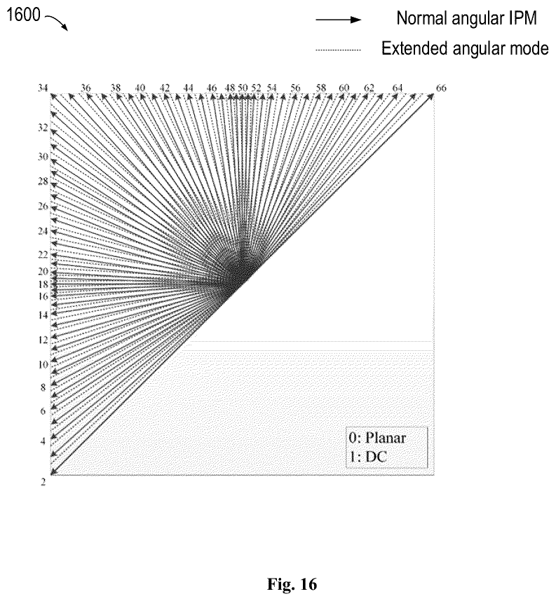

In this disclosure, the “horizontal mode” refers to the intra prediction mode with mode number being equal to 18 in FIG. 2-2. The “vertical mode” refers to the intra prediction mode with mode number being equal to 50 in FIG. 2-2. The “diagonal top-right mode” refers to the intra prediction mode with mode number being equal to 65 in FIG. 2-2. The “diagonal bottom-left mode” refers to the intra prediction mode with mode number being equal to 2 in FIG. 2-2. The “diagonal top-left mode” refers to the intra prediction mode with mode number being equal to 34 in FIG. 16. These intra prediction modes may also refer to the intra prediction modes having the same direction in HEVC.

In this disclosure, the “template” refers to a region surrounding current block (e.g., left, and/or left below, and/or left above, and/or above, and/or above right regions etc.).

### On Intra Prediction Angles and Interpolation Filter for Denser/Extended Angular Modes

1. It is proposed to use finer angles and/or higher precision of the inverse angle parameter for intra prediction of a block when one or more denser/extended angular modes are used.
   a. In one example, the denser/extended angular modes may be derived using the neighbouring samples/pixels and/or signalled in the bitstream.
   b. In one example, the block may be coded using a DIMD mode, and/or normal intra prediction mode, and/or intra prediction with subpartitions mode, and/or intra prediction with multiple reference lines mode.
   c. In one example, a first set of denser/extended intra prediction modes may be allowed to be used for the block. An example is shown in Embodiment 5.1.
      i. In one example, one or more denser/extended intra prediction modes from the first set may be derived and/or signalled, and used for intra prediction of the block.
      ii. In one example, the intra prediction angle of a denser/extended intra prediction modes may be derived using its adjacent or non-adjacent existing angular modes, and/or dependent on the existing angular modes. Denote two adjacent existing angular modes as M1 and M2, with intra prediction angles equal to A1 and A2. Denote the denser/extended intra prediction mode as M3 with intra prediction angle equal to A3.
         1) In one example, A3 is larger than A1 and less than A2.
         2) In one example, the precision of A3 may be higher than A1 and A2. Such as the precision of 1/T1 is used for A3, and the precision of 1/T2 is used for A1 and A2 wherein T1 is larger than T2.
         a) In one example, T2 is equal to 32, and T1 is equal to 64 or 128.
      iii. In one example, more intra prediction modes with wide angle may be used for the block when the block is non-square.
         1) An example is shown in Embodiment 5.1.
         2) In one example, intra prediction angles of the wide angle modes may have higher precision than the existing angular modes.
   d. In one example, higher precision may be used to derive the inverse angular parameter (e.g., invAngle) using the intra prediction angles (e.g., intraPredAngle).
      i. In one example, invAngle=f (T1*T2/intraPredAngle), wherein T1*T2 is larger than 512*32.
         1) In one example, T1=512, T2=64; or T1=1024, T2=32.
         2) In one example, f may be a function of round, or ceiling.
2. The intra prediction process for the denser/extended angular modes and other existing modes may be different.
   a. In one example, whether to and/or how to apply smooth filter may be dependent on the IPM is a denser/extended one or not.
   b. In one example, whether to and/or how to apply PDPC filter and/or Gradient PDPC filter may be dependent on the IPM is a denser/extended one or not.
c. In one example, whether to and/or how to generate a predictor according to an interpolation filter may be dependent on the IPM is a denser/extended one or not.
3. The denser/extended angular mode of a first block may be used to predict the angular mode of a second block.
   a. The first block and the second block may be in the same picture/sub-picture or slice or tile.
   b. The first block may be adjacent or non-adjacent neighbouring to the second block.
   c. The denser/extended angular mode of a first block may be treated directly as a most probable mode for the second block.
   d. The denser/extended angular mode of a first block may be mapped to an ordinary angular mode (existing angular mode) before it is treated as a most probable mode for the second block. For example, it may be mapped to an ordinary angular mode nearest to the denser/extended angular mode.
   e. Alternatively, the denser/extended angular mode of a first block may not be used to predict the angular mode of a second block.
4. It is proposed to use interpolation filter with a first precision different to that used in current video coding standards (e.g., VVC) to generate the samples at the fractional positions in the intra prediction.
   a. In one example, the first precision is higher than that used in current video coding standards (e.g., VVC).
   b. In one example, whether to and/or how to use the interpolation filter with the first precision may depend on the colour component. Wherein the interpolation filter with higher precision is used for the first colour component, and the interpolation filter with unchanged precision is used for the second colour component.
      i. In one example, the first colour component may be Y in the YCbCr format, or G in the RGB format.
      ii. In one example, the first colour component may be Cb in the YCbCr format, or B in the RGB format.
      iii. In one example, the first colour component may be Cr in the YCbCr format, or R in the RGB format.
      iv. In one example, the second colour component may be Y in the YCbCr format, or G in the RGB format.
      v. In one example, the second colour component may be Cb in the YCbCr format, or B in the RGB format.
      vi. In one example, the second colour component may be Cr in the YCbCr format, or R in the RGB format.
   c. In one example, whether to and/or how to use the interpolation filter with the first precision may depend on whether denser/extended angular modes are used.
      i. In one example, the interpolation filter with a higher precision may be used when denser/extended angular modes are used.
      ii. In one example, more than one interpolation filters with a higher precision may be allowed to be used when denser/extended angular modes are used.
         1) In one example, one of the interpolation filters with higher precision may be derived at decoder, and/or signalled in the bitstream.
         2) In one example, different interpolation filters with higher precision may be defined for each denser/extended angular mode.
   d. In one example, the precision of interpolation filter may be equal to 1/T. For example, T=2K such as T=256 or T=512.
      i. In one example, the filter may be defined as: f(x)=[a[0]ₓ, a[1]ₓ, a[2]ₓ, . . . a[N−1]ₓ] wherein x denotes the fractional position in the 1-D dimension, and a[i]ₓ denotes the i-th filter coefficient, and the filter is a N-tap filter using N samples to interpolate a sample at the fractional position, and a[0]ₓ+a[1]ₓ+a[2]ₓ+ . . .+a[N−1]ₓ=T.
         1) In one example, x may depend on the precision of intra prediction angle (e.g., P).
         a) In one example, x may be in the range from 0 to P−1 inclusive.
         b) In one example, P=32, or P=64, or P=128 .
         c) In one example, P is a number with power of 2.
         2) In one example, a[i]ₓ>=a[i]_{y} for any x<y.
         3) In one example, a[i]ₓ<=a[i]_{y} for any x<y.
         4) In one example, a[i]ₓ>=a[i]_{y} for any x<y and x, y<=P/2; a[i]ₓ<=a[i]_{y} for any x<y and x, y>P/2.
         5) In one example, a[i]ₓ<=a[i]_{y} for any x<y and x, y<=P/2; a[i]ₓ>=a[i]_{y} for any x<y and x, y>P/2.

### Determination of Coding Tools Using the Template

5. Whether to and/or how to apply a refining process (such as filtering process) on a block may depend on a template, wherein a first cost is derived by applying the refining process to the template and a second cost is derived by not applying the refining process to the template.
   a. In one example, the refining process may apply to the predicted samples and/or the reconstructed samples of the block.
   b. In one example, the block may be intra-coded, and/or inter-coded, and/or coded using a combined mode using intra and inter (e.g., CIIP).
   c. In one example, the refining process may refer to a position dependent intra prediction combination (e.g., PDPC) method, and/or a gradient position dependent intra prediction combination (e.g., Gradient PDPC) method, and/or other filtering methods which modify/refine the predicted samples and/or reconstructed samples.
   d. In one example, when the first cost is less than the second cost, the refining process may be applied to the block: Otherwise, the filtering process may not be applied to the block.
      i. Alternatively, whether to apply the refining process may depend on a function of the first cost and the second cost (e.g., comparing the difference of the first cost and the second cost to a threshold).
6. Whether to and/or how to filter the reference samples in intra prediction of a block may depend on a template, wherein a first cost (C1) is derived by filtering the reference samples during the intra prediction of the template and a second cost (C2) is derived by not filtering the reference samples during the intra prediction of the template.
   a. In one example, the block may be coded using intra mode, and/or coded using a combined mode using intra and inter (e.g., CIIP).
   b. In one example, when the first cost is less than the second cost (e.g., C1<C2), the reference samples may be filtered during the intra prediction of the block: Otherwise, the reference samples may not be filtered during the intra prediction of the block.
      i. Alternatively, whether to filter the reference samples may depend on a function of the first cost and the second cost (e.g., comparing the difference of the first cost and the second cost to a threshold).
   c. In one example, the block may refer to luma block, and/or chroma block.
   d. In one example, a third cost (C3) is derived by using a first filtering method to filter the reference samples during the intra prediction of the template and a fourth cost (C4) is derived by using a second filtering method to filter the reference samples during the intra prediction of the template. When the third cost is less than the fourth cost (e.g., C3<C4), the first filtering method may be used to filter the reference samples during the intra prediction of the block: Otherwise, the second filtering method may be used to filter the reference samples during the intra prediction of the block.
7. Whether to and/or how to derive a sample locating at a fractional position (e.g., interpolation filter) during the intra prediction of a block may depend on a template, wherein a first cost is derived by using a first interpolation filter to derive the samples located in the fractional positions during the intra prediction of the template and a second cost is derived by using a second interpolation filter.
   a. In one example, the block may be coded using intra mode, and/or coded using a combined mode using intra and inter (e.g., CIIP).
   b. In one example, when the first cost is less than the second cost, the first interpolation filter may be used during the intra prediction of the block: Otherwise, the second interpolation filter may be used during the intra prediction of the block.
      i. Alternatively, the determination of using which interpolation filter may depend on a function of the first cost and the second cost (e.g., comparing the difference of the first cost and the second cost to a threshold).

### On Usage of One or More Derived Intra Prediction Modes

8. It is proposed that the derived intra prediction mode of the current block is only utilized in the reconstruction process of current block.
   a. Alternatively, it is disallowed to be utilized in the encoding/decoding process of another block in the same video unit (e.g., picture/slice/subpicture/tile).
   b. Alternatively, it may be used in the reconstruction process of current block and filtering process (e.g., deblocking filter).
   c. Alternatively, it may also be used in the encoding/decoding process of a block in a different video unit (e.g., picture).
9. When a neighboring block is coded with the derived mode, a default mode may be assigned to the neighboring block when encoding/decoding process of a proceeding block.
   a. In one example, the default mode may be set to one of existing intra prediction mode, e.g., Planar, DC, horizontal mode, vertical mode.
   b. Alternatively, a neighboring block is treated as non-intra coded blocks or being unavailable when encoding/decoding process of a proceeding block.
10. Instead of including all the derived intra prediction modes in the primary list of intra most probable modes (MPM), it is proposed that one or more derived intra prediction modes are not included in the MPM list.
   a. In one example, the one or more derived intra prediction modes may be derived using the neighbouring reconstructed samples of current block.
      i. In one example, the derived intra prediction modes may be derived directly from a predefined IPM set (such as, using the same method as in such as JVET-00449 and/or JVET-U0100).
   b. In one example, the MPM list may refer to the primary MPM list and/or the secondary MPM list.
   c. Alternatively, it is proposed to include one or more derived intra prediction modes in the secondary MPM list.
   d. Alternatively, it is proposed to include the partial of the derived intra prediction modes in the primary and/or secondary MPM list.

### General claims

11. Whether to and/or how to apply the disclosed methods above may be signalled at sequence level/picture level/slice level/tile group level, such as in sequence header/picture header/SPS/VPS/DPS/DCI/PPS/APS/slice header/tile group header.
12. Whether to and/or how to apply the disclosed methods above may be signalled at PU/TU/CU/VPDU/CTU/CTU row/slice/tile/sub-picture.
13. Whether to and/or how to apply the disclosed methods above may be dependent on coded information, such as block size, colour format, single/dual tree partitioning, colour component, slice/picture type.

### 5. EMBODIMENTS

Below are some example embodiments for some of the invention aspects summarized above in Section 4.

### 5.1. Embodiment 1

Specification of intraPredAngle

| predModeIntra | −31 | −30 | −29 | −28 | −27 | −26 | −25 | −24 | −23 | −22 | −21 | −20 | −19 | −18 | −17 | −16 | −15 |
|---|---|---|---|---|---|---|---|---|---|---|---|---|---|---|---|---|---|
| intraPredAngle | 3072 | 2048 | 1536 | 1024 | 853 | 682 | 597 | 512 | 427 | 342 | 299 | 256 | 230 | 204 | 188 | 172 | 159 |

| predModeIntra | −14 | −13 | −12 | −11 | −10 | −9 | −8 | −7 | −6 | −5 | −4 | −3 | −2 | −1 | 2 | 3 | 4 |
|---|---|---|---|---|---|---|---|---|---|---|---|---|---|---|---|---|---|
| intraPredAngle | 146 | 137 | 128 | 121 | 114 | 108 | 102 | 96 | 90 | 84 | 78 | 74 | 70 | 67 | 64 | 61 | 58 |

| predModeIntra | 5 | 6 | 7 | 8 | 9 | 10 | 11 | 12 | 13 | 14 | 15 | 16 | 17 | 18 | 19 | 20 | 21 |
|---|---|---|---|---|---|---|---|---|---|---|---|---|---|---|---|---|---|
| intraPredAngle | 55 | 52 | 49 | 46 | 43 | 40 | 38 | 36 | 34 | 32 | 30 | 28 | 26 | 24 | 22 | 20 | 18 |
| predModeIntra | 22 | 23 | 24 | 25 | 26 | 27 | 28 | 29 | 30 | 31 | 32 | 33 | 34 | 35 | 36 | 37 | 38 |
| intraPredAngle | 16 | 14 | 12 | 10 | 8 | 7 | 6 | 5 | 4 | 3 | 2 | 1 | 0 | −1 | −2 | −3 | −4 |

| predModeIntra | 39 | 40 | 41 | 42 | 43 | 44 | 45 | 46 | 47 | 48 | 49 | 50 | 51 | 52 | 53 | 54 | 55 |
|---|---|---|---|---|---|---|---|---|---|---|---|---|---|---|---|---|---|
| intraPredAngle | −5 | −6 | −7 | −8 | −10 | −12 | −14 | −16 | −18 | −20 | −22 | −24 | −26 | −28 | −30 | −32 | −34 |

| predModeIntra | 56 | 57 | 58 | 59 | 60 | 61 | 62 | 63 | 64 | 65 | 66 | 67 | 68 | 69 | 70 | 71 | 72 |
|---|---|---|---|---|---|---|---|---|---|---|---|---|---|---|---|---|---|
| intraPredAngle | −36 | −38 | −40 | −43 | −46 | −49 | −52 | −55 | −58 | −61 | −64 | −61 | −58 | −55 | −52 | −49 | −46 |
| predModeIntra | 73 | 74 | 75 | 76 | 77 | 78 | 79 | 80 | 81 | 82 | 83 | 84 | 85 | 86 | 87 | 88 | 89 |
| intraPredAngle | −43 | −40 | −38 | −36 | −34 | −32 | −30 | −28 | −26 | −24 | −22 | −20 | −18 | −16 | −14 | −12 | −10 |

| predModeIntra | 90 | 91 | 92 | 93 | 94 | 95 | 96 | 97 | 98 | 99 | 100 | 101 | 102 | 103 | 104 | 105 | 106 |
|---|---|---|---|---|---|---|---|---|---|---|---|---|---|---|---|---|---|
| intraPredAngle | −8 | −7 | −6 | −5 | −4 | −3 | −2 | −1 | 0 | 1 | 2 | 3 | 4 | 5 | 6 | 7 | 8 |

| predModeIntra | 107 | 108 | 109 | 110 | 111 | 112 | 113 | 114 | 115 | 116 | 117 | 118 | 119 | 120 | 121 | 122 | 123 |
|---|---|---|---|---|---|---|---|---|---|---|---|---|---|---|---|---|---|
| intraPredAngle | 10 | 12 | 14 | 16 | 18 | 20 | 22 | 24 | 26 | 28 | 30 | 32 | 34 | 36 | 38 | 40 | 43 |
| predModeIntra | 124 | 125 | 126 | 127 | 128 | 129 | 130 | 131 | 132 | 133 | 134 | 135 | 136 | 137 | 138 | 139 | 140 |
| intraPredAngle | 46 | 49 | 52 | 55 | 58 | 61 | 54 | 67 | 70 | 74 | 78 | 84 | 90 | 96 | 102 | 108 | 114 |
| predModeIntra | 141 | 142 | 143 | 144 | 145 | 146 | 147 | 148 | 149 | 150 | 151 | 152 | 153 | 154 | 155 | 156 | 157 |
| intraPredAngle | 121 | 128 | 137 | 146 | 159 | 172 | 188 | 204 | 230 | 256 | 299 | 342 | 427 | 512 | 597 | 682 | 853 |

| predModeIntra | 158 | 159 | 160 | 161 |
|---|---|---|---|---|
| intraPredAngle | 1024 | 1536 | 2048 | 3072 |

### 5.2. Embodiment 2

When intraPredAngle is not equal to 0. the inverse angle parameter invAngle is derived based on intraPredAngle as follows:

$$invAngle = Round ( \frac{512 * 64}{intraPredAngle} ) \qquad ( 328 )$$

```
5.3. Embodiment 3
{
  { 0, 256, 0, 0 }, ///< 0 Integer-Pel
  { −1, 254, 4, −1 }, ///< 1
  { −3, 252, 8, −1 }, ///< 2
  { −4, 250, 12, −2 }, ///< 3
  { −5, 247, 17, −3 }, ///< 4
  { −6, 244, 21, −3 }, ///< 5
  { −7, 242, 25, −4 }, ///< 6
  { −8, 239, 29, −4 }, ///< 7
  { −9, 236, 34, −5 }, ///< 8
  { −9, 233, 38, −6 }, ///< 9
  { −10, 230, 43, −7 }, ///< 10
  { −11, 227, 47, −7 }, ///< 11
  { −12, 224, 52, −8 }, ///< 12
  { −12, 220, 56, −8 }, ///< 13
  { −13, 217, 61, −9 }, ///< 14
  { −14, 214, 65, −9 }, ///< 15
  { −14, 210, 70, −10 }, ///< 16
  { −14, 206, 75, −11 }, ///< 17
  { −15, 203, 79, −11 }, ///< 18
  { −15, 199, 84, −12 }, ///< 19
  { −16, 195, 89, −12 }, ///< 20
  { −16, 191, 93, −12 }, ///< 21
  { −16, 187, 98, −13 }, ///< 22
  { −16, 183, 102, −13 }, ///< 23
  { −16, 179, 107, −14 }, ///< 24
  { −16, 174, 112, −14 }, ///< 25
  { −16, 170, 116, −14 }, ///< 26
  { −16, 166, 121, −15 }, ///< 27
  { −17, 162, 126, −15 }, ///< 28
  { −16, 157, 130, −15 }, ///< 29
  { −16, 153, 135, −16 }, ///< 30
  { −16, 148, 140, −16 }, ///< 31
  { −16, 144, 144, −16 }, ///< 32 Half-Pel
  { −16, 140, 148, −16},
  { −16, 135, 153, −16},
  { −15, 130, 157, −16},
  { −15, 126, 162, −17},
  { −15, 121, 166, −16},
  { −14, 116, 170, −16},
  { −14, 112, 174, −16},
  { −14, 107, 179, −16},
  { −13, 102, 183, −16},
  { −13, 98, 187, −16},
  { −12, 93, 191, −16},
  { −12, 89, 195, −16},
  { −12, 84, 199, −15},
  { −11, 79, 203, −15},
  { −11, 75, 206, −14},
  { −10, 70, 210, −14},
  { −9, 65, 214, −14},
  { −9, 61, 217, −13},
  { −8, 56, 220, −12},
  { −8, 52, 224, −12},
  { −7, 47, 227, −11},
  { −7, 43, 230, −10},
  { −6, 38, 233, −9},
  { −5, 34, 236, −9},
  { −4, 29, 239, −8},
  { −4, 25, 242, −7},
  { −3, 21, 244, −6},
  { −3, 17, 247, −5},
  { −2, 12, 250, −4},
  { −1, 8, 252, −3},
  { −1, 4, 254, −1},
};
5.4. Embodiment 4
{
  { 47, 161, 47, 1 }, ///< 0 Integer-Pel
  { 45, 161, 49, 1 }, ///< 1
  { 43, 161, 51, 1 }, ///< 2
  { 42, 160, 52, 2 }, ///< 3
  { 40, 160, 54, 2 }, ///< 4
  { 38, 160, 56, 2 }, ///< 5
  { 37, 159, 58, 2 }, ///< 6
  { 35, 158, 61, 2 }, ///< 7
  { 34, 158, 62, 2 }, ///< 8
  { 32, 157, 65, 2 }, ///< 9
  { 31, 156, 67, 2 }, ///< 10
  { 29, 155, 69, 3 }, ///< 11
  { 28, 154, 71, 3 }, ///< 12
  { 27, 153, 73, 3 }, ///< 13
  { 26, 151, 76, 3 }, ///< 14
  { 25, 150, 78, 3 }, ///< 15
  { 23, 149, 80, 4 }, ///< 16
  { 22, 147, 83, 4 }, ///< 17
  { 21, 146, 85, 4 }, ///< 18
  { 20, 144, 87, 5 }, ///< 19
  { 19, 142, 90, 5 }, ///< 20
  { 18, 141, 92, 5 }, ///< 21
  { 17, 139, 94, 6 }, ///< 22
  { 16, 137, 97, 6 }, ///< 23
  { 16, 135, 99, 6 }, ///< 24
  { 15, 133, 101, 7 }, ///< 25
  { 14, 131, 104, 7 }, ///< 26
  { 13, 129, 106, 8 }, ///< 27
  { 13, 127, 108, 8 }, ///< 28
  { 12, 125, 111, 8 }, ///< 29
  { 11, 123, 113, 9 }, ///< 30
  { 11, 120, 116, 9 }, ///< 31
  { 10, 118, 118, 10 }, ///< 32 Half-Pel
  { 9, 116, 120, 11},
  { 9, 113, 123, 11},
  { 8, 111, 125, 12},
  { 8, 108, 127, 13},
  { 8, 106, 129, 13},
  { 7, 104, 131, 14},
  { 7, 101, 133, 15},
  { 6, 99, 135, 16},
  { 6, 97, 137, 16},
  { 6, 94, 139, 17},
  { 5, 92, 141, 18},
  { 5, 90, 142, 19},
  { 5, 87, 144, 20},
  { 4, 85, 146, 21},
  { 4, 83, 147, 22},
  { 4, 80, 149, 23},
  { 3, 78, 150, 25},
  { 3, 76, 151, 26},
  { 3, 73, 153, 27},
  { 3, 71, 154, 28},
  { 3, 69, 155, 29},
  { 2, 67, 156, 31},
  { 2, 65, 157, 32},
  { 2, 62, 158, 34},
  { 2, 61, 158, 35},
  { 2, 58, 159, 37},
  { 2, 56, 160, 38},
  { 2, 54, 160, 40},
  { 2, 52, 160, 42},
  { 1, 51, 161, 43},
  { 1, 49, 161, 45},
};
```

The present discourse mainly relates to intra prediction procedure. In particular, some embodiments relates to a scenario where denser/extended angular modes are introduced for the current block.

The term “syntax element” used herein may refer to a flag, an index or any other suitable element for signaling information.

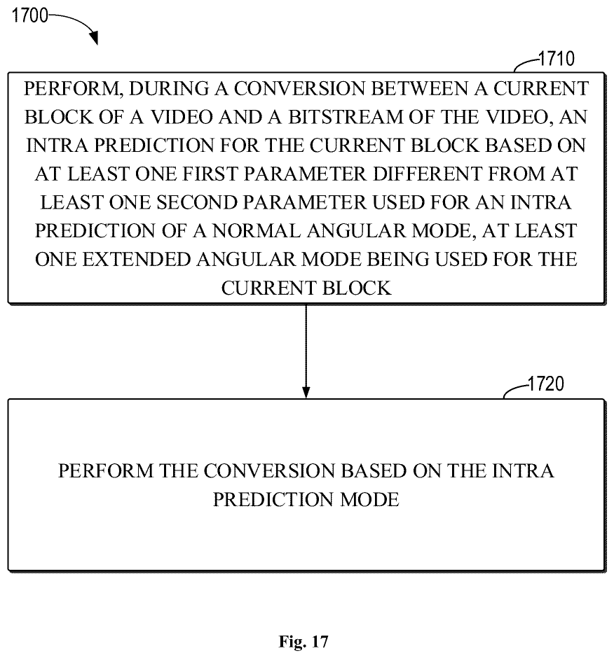

FIG. 17 illustrates a flowchart of a method 1700 of processing video data in accordance with some embodiments of the present disclosure. As shown in FIG. 17, the method 1700 starts at 1710, where during a conversion between a current block of a video and a bitstream of the video, an intra prediction for the current block is performed based on at least one first parameter different from at least one second parameter used for an intra prediction of a normal angular mode. The current block is used with at least one extended angular mode. At 1720, the conversion is performed based on the intra prediction mode.

The method 1700 enables that an extended angular mode may be derived and used for the current block. In this way, the precision of the intra prediction mode used by the current block is improved and the coding efficiency is improved thereby.

Implementations of the present disclosure can be described in view of the following clauses, the features of which can be combined in any reasonable manner.

In some embodiments, the at least one extended angular mode is determined by neighbouring samples. Alternatively or in addition, the at least one extended angular mode is determined by neighbouring pixels. In this way, the prediction of parameter for determining the extended angular mode is improved.

In some embodiments, the current block may be coded any suitable mode. One example mode is a decoder side intra mode derivation mode. Another example mode is an intra prediction mode. A further example mode is an intra prediction with subpartitions mode. A further mode is an intra prediction with multiple reference lines mode. It is to be understood that the above example modes are only for the purpose of illustration without suggesting any limitations.

In some embodiments, the at least one extended angular mode is determined from a predefined set. In this way, the computation consumption is reduced.

In some embodiments, the at least one extended angular comprised in the predefined set is indicated in the bitstream or derived at an encoder or decoder.

In some embodiments, an extended angular mode of the predefined set is derived from two pre-defined angular modes comprised in an intra prediction mode set predefined for intra prediction, the two pre-defined angular modes being adjacent or non-adjacent to each other.

In some embodiments, an angle value of the extended angular mode is between angle values of the two pre-defined angular modes.

In some embodiments, an angle precision of the extended angular mode is higher than at least one of angle precisions of the two pre-defined angular modes.

In some embodiments, the angle precision of the extended angular mode is 1/64. Alternatively, the angle precision of the extended angular mode is or 1/128.

In some embodiments, the predefined set comprises at least one intra prediction mode with wide angle if the current block is non-square, and the number of intra prediction modes with wide angle used for the predefined set is larger than a preset value.

In some embodiments, an angle precision of the at least one intra prediction modes with wide angle is higher than a predefined angle precision.

In some embodiments, the at least one first parameter is determined using intra prediction angles.

In some embodiments, the at least one first parameter is further determined using a first value and a second value. For example, the product of the first and second values is larger than or equals to 512*32. It is to be understood that the numbers illustrated herein are merely for are only for the purpose of illustration without suggesting any limitations.

In some embodiments, the first value is 512 and the second value is 64. Alternatively, in some embodiments, the first value is 1024 and the second value is 32.

In some embodiments, the at least one first parameter is an inverse angular parameter and may be derived by several ways. For example, the inverse angular parameter may be determined according to:

inverse angular parameter=function (first value*second value/intra prediction angles), where the function is a function of round. Alternatively, the function is a function of ceiling.

In some embodiments, the method 1700 may further comprise: determining, based on the extended angular mode, a further intra prediction mode for a further block.

In some embodiments, the current block and the further block are in the same code unit, such as, a picture, sub-picture or slice or tile of the video.

In some embodiments, the further block is adjacent or non-adjacent to the current block.

In some embodiments, determining 1710 the further intra prediction mode comprises: constructing, based on the extended angular mode, a most probable mode list for the further block of the video; and determining the further intra prediction mode based on most probable mode list.

In some embodiments, constructing the most probable mode list based on the extended angular mode comprises: including the extended angular mode into the most probable mode list. Alternatively, constructing the most probable mode list based on the extended angular mode comprises: excluding the extended angular mode from the most probable mode list.

In some embodiments, constructing the most probable mode list based on the extended angular mode comprises: mapping the extended angular mode to a predefined angular mode; and including the mapped predefined angular mode into the most probable mode list.

In some embodiments, the predefined angular mode is a normal angular mode nearest to the extended angular mode.

In some embodiments, the at least one first parameter is indicated in the bitstream at any suitable level. By way of example, the at least one first parameter is indicated at sequence level. Alternatively, the at least one first parameter also may be indicated at group of pictures level. Alternatively, the at least one first parameter also may be indicated at picture level. Alternatively, the at least one first parameter also may be indicated at slice level. Alternatively, the at least one first parameter also may be indicated at tile group level.

In some embodiments, the at least one first parameter is represented as a syntax element. The term “syntax element” used herein may refer to a flag, an index or any other suitable element for signaling information. The syntax element may be signalled in various forms. By way of examples, the syntax element is included in a VPS. Alternatively, the syntax element is included in an SPS. Alternatively, the syntax element is included in a PPS. Alternatively, the syntax element is included in a DPS. Alternatively, the syntax element is included in a DCI. Alternatively, the syntax element is included in an APS. Alternatively, the syntax element is included in a sequence header. Alternatively, the syntax element is included in a picture header. Alternatively, the syntax element is included in a sub-picture header. Alternatively, the syntax element is included in a slice header. Alternatively, the syntax element is included in a tile header.

In some embodiments, the at least one parameter is indicated at any suitable region. By way of examples, the at least one parameter is indicated at a PB. Alternatively, the at least one parameter is indicated at a TB. Alternatively, the at least one parameter is indicated at a CB. Alternatively, the at least one parameter is indicated at a PU. Alternatively, the at least one parameter is indicated at a TU. Alternatively, the at least one parameter is indicated at a CU. Alternatively, the at least one parameter is indicated at a VPDU. Alternatively, the at least one parameter is indicated at a CTU. Alternatively, the at least one parameter is indicated at a CTU row. Alternatively, the at least one parameter is indicated at a slice. Alternatively, the at least one parameter is indicated at a tile. Alternatively, the at least one parameter is indicated at a sub-picture.

In some embodiments, the conversion is performed based on coded information.

In some embodiments, the coded information may comprise any suitable information. In one example, the coded information is a block size. Alternatively, in a further example, the coded information is a colour format. In another example, the coded information is a single/dual tree partitioning. Alternatively, the information may be other suitable, such as, a colour component, a slice type, or a picture type.

In some embodiments, performing 1720 the conversion comprises: encoding the current block into the bitstream based on the intra prediction mode.

In some embodiments, performing 1720 the conversion comprises: decoding the current block from the bitstream based on the intra prediction mode.

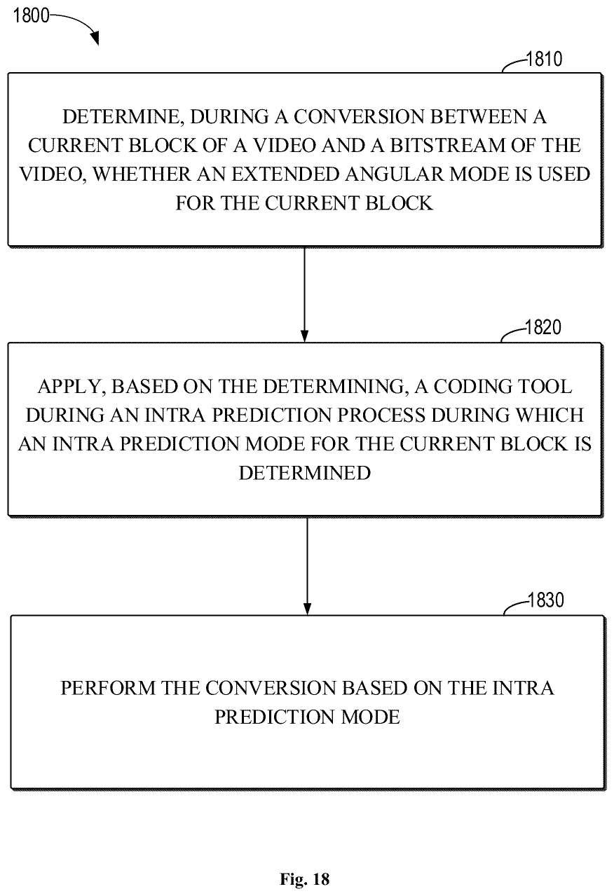

FIG. 18 illustrates a flowchart of a method 1800 of processing video data in accordance with some embodiments of the present disclosure. As shown in FIG. 18, the method 1800 starts at 1810, where during a conversion between a current block of a video and a bitstream of the video, whether an extended angular mode is used for the current block is determined. At 1820, a coding tool during an intra prediction process during which an intra prediction mode for the current block is determined based on the determining. At 1830, the conversion based on the intra prediction mode is performed.

The method 1800 applies the coding tool based on a determination whether an extended angular mode is used for the current block, which makes the coding tool may be applied more reasonable and the coding efficiency is improved thereby.

Implementations of the present disclosure can be described in view of the following clauses, the features of which can be combined in any reasonable manner.

In some embodiments, the coding tool is a smooth filter. Alternatively or in addition, the coding tool is a position dependent intra prediction combination (PDPC) filter. Alternatively or in addition, the coding tool is a gradient PDPC filter. Alternatively or in addition, the coding tool is an interpolation filter.

In some embodiments, applying 1820 the coding tool comprises: applying at least one interpolation filter with a first precision different from a second precision to generate samples at fractional positions, the second precision being used for a situation where a normal angular mode is used for the current block.

In some embodiments, the first precision is higher than the second precision.

In some embodiments, applying 1820 the coding tool comprises: applying the at least one interpolation filter with the first precision based on colour components.

In some embodiments, applying 1820 the coding tool comprises: applying the at least one interpolation filter with the first precision to a first colour component; and applying at least one interpolation filter with the second precision to a second colour component.

In some embodiments, either the first or second colour components is a colour component Y, Cb or Cr in a YCbCr format. Alternatively, either the first or second colour components is a colour component R, G and B in an RGB format.

In some embodiments, applying 1820 the at least one interpolation filter with the first precision comprises: applying the at least one interpolation filter with the first precision if an extended angular mode is used for the current block.

In some embodiments, the at least one interpolation filter with the first precision belongs to an interpolation filter set allowed to be used for a situation where an extended angular mode is used for the current block.

In some embodiments, the at least one interpolation filter with the first precision is derived at a decoder. Alternatively, the interpolation filter with the first precision is included in the bitstream.

In some embodiments, different interpolation filters comprised in the interpolation filter set are defined for different extended angular modes.

In some embodiments, a precision of the interpolation filter equals to 1/T, wherein T is an integer equaling to T=2K, where K is an integer lager than 6.

In some embodiments, an interpolation filter of the at least one interpolation filter is a N-tap filter using N samples to interpolate a sample at a fractional position, wherein N is the number of taps of the interpolation filter; and the interpolation filter is defined by: f(x)=[a[0]ₓ, a[1]ₓ, a[2]ₓ, . . . a[N−1]ₓ], where, x represents a fractional position, a[i]x represents the i-th filter coefficient for the fractional position x, and a[0]ₓ+a[1]ₓ+a[2]ₓ+ . . . +a[N−1]ₓ=T.

In some embodiments, the maximum of the fractional position x depends on a precision of intra prediction angle.

In some embodiments, a value of the fractional position x is larger than 0 and smaller than the precision of intra prediction angle.

In some embodiments, the precision of intra prediction angle is a number with power of 2.

In some embodiments, the precision of intra prediction angle is one of 32, 64 or 128. It is to be understood that the numbers illustrated herein are merely for are only for the purpose of illustration without suggesting any limitations.

In some embodiments, values of filter coefficients of the interpolation filter are in a descending order according to values the fractional position x.

In some embodiments, values of filter coefficients of the interpolation filter are in an ascending according to values the fractional position x.

In some embodiments, values of filter coefficients of the interpolation filter are in an ascending if the fractional position x is small than or equals to a value of half of the precision of intra prediction angle; and values of filter coefficients of the interpolation filter are in a descending if the fractional position x is larger than the value of half of the precision of intra prediction angle.

In some embodiments, values of filter coefficients of the interpolation filter are in a descending if the fractional position x is small than or equals to a value of half of the precision of intra prediction angle; and values of filter coefficients of the interpolation filter are in an ascending if the fractional position x is larger than the value of half of the precision of intra prediction angle.

In some embodiments, information for applying the coding tool is indicated at any suitable level. By way of example, the at least one first parameter is indicated at sequence level. Alternatively, the at least one first parameter also may be indicated at group of pictures level. Alternatively, the at least one first parameter also may be indicated at picture level. Alternatively, the at least one first parameter also may be indicated at slice level. Alternatively, the at least one first parameter also may be indicated at tile group level.

In some embodiments, the information is represented as a syntax element. The term “syntax element” used herein may refer to a flag, an index or any other suitable element for signaling information. The syntax element may be signalled in various forms. By way of examples, the syntax element is included in a VPS. Alternatively, the syntax element is included in an SPS. Alternatively, the syntax element is included in a PPS. Alternatively, the syntax element is included in a DPS. Alternatively, the syntax element is included in a DCI. Alternatively, the syntax element is included in an APS. Alternatively, the syntax element is included in a sequence header. Alternatively, the syntax element is included in a picture header. Alternatively, the syntax element is included in a sub-picture header. Alternatively, the syntax element is included in a slice header. Alternatively, the syntax element is included in or a tile header.

In some embodiments, the information is indicated at any suitable region. By way of examples, the information is indicated at a PB. Alternatively, the information is indicated at a TB. Alternatively, the information is indicated at a CB. Alternatively, the information is indicated at a PU. Alternatively, the information is indicated at a TU. Alternatively, the information is indicated at a CU. Alternatively, the information is indicated at a VPDU. Alternatively, the information is indicated at a CTU. Alternatively, the information is indicated at a CTU row. Alternatively, the information is indicated at a slice. Alternatively, the information is indicated at a tile. Alternatively, the information is indicated at a sub-picture.

In some embodiments, the conversion is performed based on coded information.

In some embodiments, the coded information may comprise any suitable information. In one example, the coded information is a block size. Alternatively, in a further example, the coded information is a colour format. In another example, the coded information is a single/dual tree partitioning. Alternatively, the information may be other suitable, such as, a colour component, a slice type, or a picture type.

In some embodiments, performing 1830 the conversion comprises: encoding the current block into the bitstream based on the intra prediction mode.

In some embodiments, performing 1830 the conversion comprises: decoding the current block from the bitstream based on the intra prediction mode.

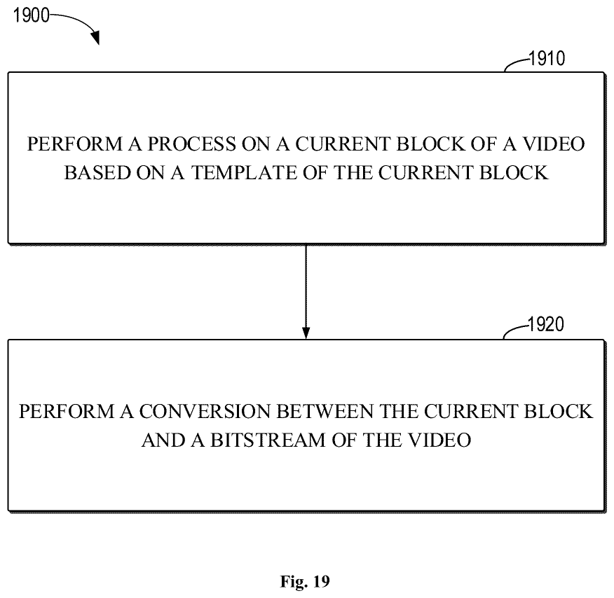

FIG. 19 illustrates a flowchart of a method 1900 of processing video data in accordance with some embodiments of the present disclosure. As shown in FIG. 19, the method 1900 starts at 1910, where a process on a current block of a video based on a template of the current block is performed. In one example, the process is a refining process. In another example, the process is a process of filtering reference samples. In further example, the process is a process of determining a sample locating at a fractional position. At 1920, a conversion between the current block and a bitstream of the video is performed.

The method 1900 performs the refining process based on a template of the current block, which makes that the refining process is performed on demand.

Implementations of the present disclosure can be described in view of the following clauses, the features of which can be combined in any reasonable manner.

In some embodiments, the current block is coded with an intra-coded mode. Alternatively, the current block is coded with an inter-coded mode. Alternatively, the current block is coded with a combined inter and intra prediction mode.

In some embodiments, the process is the refining process and performing 1910 the process comprises: determining the following for the current block: a first cost, determined by applying the refining process to the template, and a second cost, determined by not applying the refining process to the template; and applying the refining process to the current block based on the first and second costs.

In some embodiments, applying the refining process to the current block based on the first and second costs comprises: applying the refining process to the current block if the first cost is smaller than the second cost. Alternatively, applying the refining process to the current block based on the first and second costs comprises: applying the refining process to the current block if a difference between the second cost and the first is larger than a threshold.

In some embodiments, applying the refining process comprises: applying the refining process to predicted samples of the current block. Alternatively or in addition, applying the refining process comprises: applying the refining process to reconstructed samples of the current block.

In some embodiments, the refining process is: a filtering process for refining at least one of predicted samples of the current block and reconstructed samples of the current block.

In some embodiments, the refining process is a position dependent intra prediction combination (PDPC) process. Alternatively, the refining process is a gradient PDPC process.

In some embodiments, the process is a process of filtering reference samples and performing 1910 the process comprises: determining the following for the current block: a third cost, determined by filtering reference samples of the current block during an intra prediction of the template, and a fourth cost, de determined rived by not filtering the reference samples of the current block during the intra prediction of the template; and filtering the reference samples based on the third and fourth costs.

In some embodiments, filtering the reference samples based on the third and fourth costs comprises: filtering the reference samples during the intra prediction based on the third if the third cost is smaller than the fourth cost. Alternatively, filtering the reference samples based on the third and fourth costs comprises: filtering the reference samples during the intra prediction based on the third if a difference between the fourth cost and the third is larger than a threshold.

In some embodiments, the process is a process of filtering reference samples and performing 1910 the process comprises: determining the following for the current block: a fifth cost, determined by using a first filtering method to filter reference samples during an intra prediction of the template, and a sixth cost, determined by using a second filtering method to filter the reference samples during the intra prediction of the template; and filtering the reference samples based on the fifth and sixth costs.

In some embodiments, filtering the reference samples based on the fifth and sixth costs comprises: filtering the reference samples during the intra prediction of the template by using the first filtering method if the fifth cost is smaller than or equals to the sixth cost. Alternatively, filtering the reference samples based on the fifth and sixth costs comprises: filtering the reference samples during the intra prediction of the template by using the second filtering method if the fifth cost is larger than or equals to the sixth cost.

In some embodiments, filtering the reference samples based on the fifth and sixth costs comprises: filtering the reference samples during the intra prediction by using the first filtering method if a difference between the sixth cost and the fifth is larger than or equals to a threshold. Alternatively, filtering the reference samples based on the fifth and sixth costs comprises: filtering the reference samples during the intra prediction by using the second filtering method if a difference between the sixth cost and the fifth is smaller than or equals to the threshold.

In some embodiments, the current block is a luma block. Alternatively, the current block is a chroma block.

In some embodiments, the process is a process of determining a sample locating at a fractional position and performing 1910 the process comprises: determining the following for the current block: a seventh cost, determined by using a first interpolation filter to determine samples located in fractional positions during an intra prediction of the template, and an eighth cost, determined by using a second interpolation filter to determine the samples located in the fractional positions during the intra prediction of the template; and determining the sample locating at the fractional position based on the seventh and eighth costs.

In some embodiments, determining the sample locating at the fractional position based on the seventh and eighth costs comprises: determining the sample locating at the fractional position by using the first interpolation filter if the seventh cost is smaller than or equals to the eighth cost. Alternatively, determining the sample locating at the fractional position based on the seventh and eighth costs comprises: determining the sample locating at the fractional position by using the second interpolation filter if the seventh cost is larger than or equals to the eighth cost.

In some embodiments, determining the sample locating at the fractional position based on the seventh and eighth costs comprises: determining the sample locating at the fractional position by using the interpolation filter if a difference between the eighth cost and the seventh is larger than or equals to a threshold. Alternatively, determining the sample locating at the fractional position based on the seventh and eighth costs comprises: determining the sample locating at the fractional position by using the interpolation filter if a difference between the eighth cost and the seventh is smaller than or equals to a threshold.

In some embodiments, information for performing the process is indicated at any suitable level. By way of example, the at least one first parameter is indicated at sequence level. Alternatively, the at least one first parameter also may be indicated at group of pictures level. Alternatively, the at least one first parameter also may be indicated at picture level. Alternatively, the at least one first parameter also may be indicated at slice level. Alternatively, the at least one first parameter also may be indicated at tile group level.

In some embodiments, the information is represented as a syntax element. The term “syntax element” used herein may refer to a flag, an index or any other suitable element for signaling information. The syntax element may be signalled in various forms. By way of examples, the syntax element is included in a VPS. Alternatively, the syntax element is included in an SPS. Alternatively, the syntax element is included in a PPS. Alternatively, the syntax element is included in a DPS. Alternatively, the syntax element is included in a DCI. Alternatively, the syntax element is included in an APS. Alternatively, the syntax element is included in a sequence header. Alternatively, the syntax element is included in a picture header. Alternatively, the syntax element is included in a sub-picture header. Alternatively, the syntax element is included in a slice header. Alternatively, the syntax element is included in or a tile header.

In some embodiments, the information is indicated at any suitable region. By way of examples, the information is indicated at a PB. Alternatively, the information is indicated at a TB. Alternatively, the information is indicated at a CB. Alternatively, the information is indicated at a PU. Alternatively, the information is indicated at a TU. Alternatively, the information is indicated at a CU. Alternatively, the information is indicated at a VPDU. Alternatively, the information is indicated at a CTU. Alternatively, the information is indicated at a CTU row. Alternatively, the information is indicated at a slice. Alternatively, the information is indicated at a tile. Alternatively, the information is indicated at a sub-picture.

In some embodiments, the conversion is performed based on coded information.

In some embodiments, the coded information may comprise any suitable information. In one example, the coded information is a block size. Alternatively, in a further example, the coded information is a colour format. In another example, the coded information is a single/dual tree partitioning. Alternatively, the information may be other suitable, such as, a colour component, a slice type, or a picture type.

In some embodiments, performing 1920 the conversion comprises: encoding the current block into the bitstream.

In some embodiments, performing 1920 g the conversion comprises: decoding the current block from the bitstream.

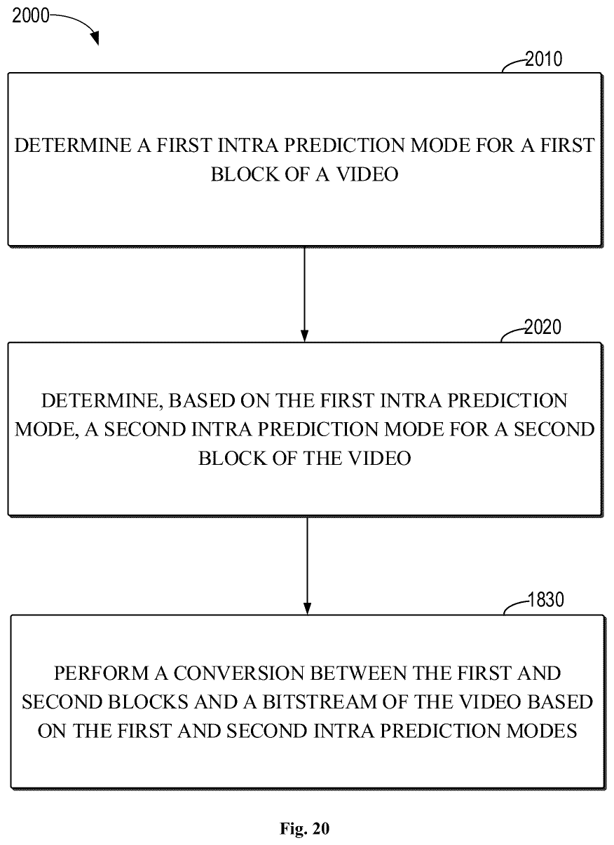

FIG. 20 illustrates a flowchart of a method 2000 of processing video data in accordance with some embodiments of the present disclosure. As shown in FIG. 20, the method 2000 starts at 2010, where a first intra prediction mode for a first block of a video is determined. At 2020, a second intra prediction mode for a second block of the video is determined based on the first intra prediction mode by excluding the first intra prediction mode during determining the second intra prediction mode for the second block if the first and second block are in a same video. Alternatively, the second intra prediction mode for a second block of the video is determined based on the first intra prediction mode by including the first intra prediction mode during determining the second intra prediction mode for the second block if the first and second block are in a different video. At 2030, a conversion between the first and second blocks and a bitstream of the video is performed based on the first and second intra prediction modes.

The method 2000 utilizes the derived intra prediction mode for a first block to derive a further intra prediction mode of for a second block, which makes the determination of the further intra prediction mode is more reasonable and the coding efficiency is improved thereby.

Implementations of the present disclosure can be described in view of the following clauses, the features of which can be combined in any reasonable manner.

In some embodiments, the method 2000 further comprises applying the first intra prediction mode during at least one of a reconstruction process and a filtering process for the first block.

In some embodiments, the second block is a neighboring block of the first block and determining 2020 the second intra prediction mode for the second block comprises: determining the second intra prediction mode for the second block as the first intra prediction mode is a default mode. Alternatively, the second block is a neighboring block of the first block and determining 2020 the second intra prediction mode for the second block comprises: determining the second intra prediction mode for the second block as the first block is a non-intra coded block.

In some embodiments, the default mode is one of the following: a planar mode, a DC mode, a horizontal mode, a vertical mode.

In some embodiments, the method 2000 further comprises determining a third intra prediction mode for a first block, wherein determining 2020 the second intra prediction mode for the second block comprises: constructing, based on the first and third prediction modes, a most probable mode list for the second block; and determining the second intra prediction mode for the second block based on the most probable mode list.

In some embodiments, constructing the most probable mode comprises: constructing the most probable mode by at least partly excluding the first and third intra prediction modes.

In some embodiments, the first and third intra prediction modes are derived from neighbouring reconstructed samples of the first block.

In some embodiments, the most probable mode list is a primary most probable mode list. Alternatively, the most probable mode list is a secondary most probable mode list. Alternatively, the most probable mode list is a primary and secondary most probable mode list.

In some embodiments, constructing the most probable mode comprises: constructing the secondary most probable mode by including the first and third intra prediction modes. Alternatively, constructing the most probable mode comprises: constructing the secondary most probable mode by partially including the first and third intra prediction modes. Alternatively, constructing the most probable mode comprises: constructing the primary most probable mode by partially including the first and third intra prediction modes.

In some embodiments, information for processing video data is indicated at any suitable level. By way of example, the at least one first parameter is indicated at sequence level. Alternatively, the at least one first parameter also may be indicated at group of pictures level. Alternatively, the at least one first parameter also may be indicated at picture level. Alternatively, the at least one first parameter also may be indicated at slice level. Alternatively, the at least one first parameter also may be indicated at tile group level.

In some embodiments, the information is represented as a syntax element. The term “syntax element” used herein may refer to a flag, an index or any other suitable element for signaling information. The syntax element may be signalled in various forms. By way of examples, the syntax element is included in a VPS. Alternatively, the syntax element is included in an SPS. Alternatively, the syntax element is included in a PPS. Alternatively, the syntax element is included in a DPS. Alternatively, the syntax element is included in a DCI. Alternatively, the syntax element is included in an APS. Alternatively, the syntax element is included in a sequence header. Alternatively, the syntax element is included in a picture header. Alternatively, the syntax element is included in a sub-picture header. Alternatively, the syntax element is included in a slice header. Alternatively, the syntax element is included in or a tile header.

In some embodiments, the information is indicated at any suitable region. By way of examples, the information is indicated at a PB. Alternatively, the information is indicated at a TB. Alternatively, the information is indicated at a CB. Alternatively, the information is indicated at a PU. Alternatively, the information is indicated at a TU. Alternatively, the information is indicated at a CU. Alternatively, the information is indicated at a VPDU. Alternatively, the information is indicated at a CTU. Alternatively, the information is indicated at a CTU row. Alternatively, the information is indicated at a slice. Alternatively, the information is indicated at a tile. Alternatively, the information is indicated at a sub-picture.

In some embodiments, the conversion is performed based on coded information.

In some embodiments, the coded information may comprise any suitable information. In one example, the coded information is a block size. Alternatively, in a further example, the coded information is a colour format. In another example, the coded information is a single/dual tree partitioning. Alternatively, the information may be other suitable, such as, a colour component, a slice type, or a picture type.

In some embodiments, performing 2030 the conversion comprises: encoding the first and second blocks into the bitstream based on the first and second intra prediction modes.

In some embodiments, performing 2030 g the conversion comprises: decoding the first and second blocks from the bitstream based on the first and second intra prediction modes.

Clause 1. A method of processing video data, comprising: performing, during a conversion between a current block of a video and a bitstream of the video, an intra prediction for the current block based on at least one first parameter different from at least one second parameter used for an intra prediction of a normal angular mode, at least one extended angular mode being used for the current block; and performing the conversion based on the intra prediction mode.

Clause 2. The method of clause 1, wherein the at least one extended angular mode is determined by at least one of the following: neighbouring samples, or neighbouring pixels.

Clause 3. The method of clause 1, wherein the current block is coded using one of the following: a decoder side intra mode derivation mode, an intra prediction mode, an intra prediction with subpartitions mode, or an intra prediction with multiple reference lines mode.

Clause 4. The method of clause 1, wherein the at least one extended angular mode is determined from a predefined set.

Clause 5. The method of clause 4, wherein the at least one extended angular mode comprised in the predefined set is indicated in the bitstream or derived at an encoder or decoder.

Clause 6. The method of clause 4, wherein an extended angular mode of the predefined set is derived from two pre-defined angular modes comprised in an intra prediction mode set predefined for intra prediction, the two pre-defined angular modes being adjacent or non-adjacent to each other.

Clause 7. The method of clause 6, wherein an angle value of the extended angular mode is between angle values of the two pre-defined angular modes.

Clause 8. The method of clause 6, wherein an angle precision of the extended angular mode is higher than at least one of angle precisions of the two pre-defined angular modes.

Clause 9. The method of clause 6, wherein the angle precision of the extended angular mode is 1/64 or 1/128.

Clause 10. The method of clauses 4, wherein the predefined set comprises at least one intra prediction mode with wide angle if the current block is non-square, and the number of intra prediction modes with wide angle used for the predefined set is larger than a preset value.

Clause 11. The method of clause 10, wherein an angle precision of the at least one intra prediction modes with wide angle is higher than a predefined angle precision.

Clause 12. The method of clause 1, wherein the at least one first parameter is determined using intra prediction angles.

Clause 13. The method of clause 12, wherein the at least one first parameter is further determined using a first value and a second value, the product of the first and second values is larger than or equals to 512*32.

Clause 14. The method of clause 13, wherein the first value is 512 and the second value is 64, or the first value is 1024 and the second value is 32.

Clause 15. The method of clause 13, wherein the at least one first parameter is an inverse angular parameter and derived by: inverse angular parameter=function (first value*second value/intra prediction angles), wherein the function is a function of round or a function of ceiling.

Clause 16. The method of clause 1, determining, based on the extended angular mode, a further intra prediction mode for a further block.

Clause 17. The method of clause 16, wherein the current block and the further block are in the same picture, sub-picture or slice or tile of the video.

Clause 18. The method of clause 16, wherein the further block is adjacent or non-adjacent to the current block.

Clause 19. The method of clause 16, wherein determining the further intra prediction mode comprises: constructing, based on the extended angular mode, a most probable mode list for the further block of the video; and determining the further intra prediction mode based on most probable mode list.

Clause 20. The method of clause 19, wherein constructing the most probable mode list based on the extended angular mode comprises one of the following: including the extended angular mode into the most probable mode list; or excluding the extended angular mode from the most probable mode list.

Clause 21. The method of clause 19, wherein constructing the most probable mode list based on the extended angular mode comprises: mapping the extended angular mode to a predefined angular mode; and including the mapped predefined angular mode into the most probable mode list.

Clause 22. The method of clause 21, wherein the predefined angular mode is a normal angular mode nearest to the extended angular mode.

Clause 23. The method of clause 1, wherein the at least one first parameter is indicated at one of the following: a sequence level, a group of pictures level, a picture level, a slice level, or a tile group level.

Clause 24. The method of clause 1, wherein the at least one first parameter is represented as a syntax element being included in one of: a video parameter set (VPS), a sequence parameter set (SPS), a picture parameter set (PPS), a dependency parameter set (DPS), a decoding capability information (DCI), an adaptation parameter set (APS), a sequence header, a picture header, a sub-picture header, a slice header, or a tile header.

Clause 25. The method of clause 1, wherein the at least one parameter is indicated at one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

Clause 26. The method of clause 1, wherein the conversion is performed based on coded information.

Clause 27. The method of clause 25, wherein the coded information comprises at least one of the following: a block size, a colour format, a single/dual tree partitioning, a colour component, a slice type, or a picture type.

Clause 28. The method of clause 1, wherein performing the conversion comprises: encoding the current block into the bitstream based on the intra prediction mode.

Clause 29. The method of clause 1, wherein performing the conversion comprises: decoding the current block from the bitstream based on the intra prediction mode.

Clause 30. A method of processing video data, comprising: determining, during a conversion between a current block of a video and a bitstream of the video, whether an extended angular mode is used for the current block; applying, based on the determining, a coding tool during an intra prediction process during which an intra prediction mode for the current block is determined; and performing the conversion based on the intra prediction mode.

Clause 31. The method of clause 30, wherein the coding tool is one of the following:

a smooth filter, a position dependent intra prediction combination (PDPC) filter, a gradient PDPC filter, or an interpolation filter.

Clause 32. The method of clause 30, wherein applying the coding tool comprises:

applying at least one interpolation filter with a first precision different from a second precision to generate samples at fractional positions, the second precision being used for a situation where a normal angular mode is used for the current block.

Clause 33. The method of clause 32, wherein the first precision is higher than the second precision.

Clause 34. The method of clause 32, wherein applying the coding tool comprises:

applying the at least one interpolation filter with the first precision based on colour components.

Clause 35. The method of clause 32, wherein applying the coding tool comprises: applying the at least one interpolation filter with the first precision to a first colour component; and applying at least one interpolation filter with the second precision to a second colour component.

Clause 36. The method of clause 35, wherein either the first or second colour components is one of the following: a colour component Y, Cb or Cr in a YCbCr format, or a colour component R, G and B in an RGB format.

Clause 37. The method of clause 32, wherein applying the at least one interpolation filter with the first precision comprises: applying the at least one interpolation filter with the first precision if an extended angular mode is used for the current block.

Clause 38. The method of clause 32, wherein the at least one interpolation filter with the first precision belongs to an interpolation filter set allowed to be used for a situation where an extended angular mode is used for the current block.

Clause 39. The method of clause 32, wherein the at least one interpolation filter with the first precision is derived at a decoder or included in the bitstream.

Clause 40. The method of clause 38, wherein different interpolation filters comprised in the interpolation filter set are defined for different extended angular modes.

Clause 41. The method of clause 31, wherein a precision of the interpolation filter equals to 1/T, wherein T is an integer equaling to T=2K, where K is an integer lager than 6.

Clause 42. The method of clause 31, wherein an interpolation filter of the at least one interpolation filter is a N-tap filter using N samples to interpolate a sample at a fractional position, wherein N is the number of taps of the interpolation filter; and wherein the interpolation filter is defined by: f(x)=[a[0]ₓ, a[1]ₓ, a[2]ₓ, . . . a[N−1]ₓ], where, x represents a fractional position, a[i]x represents the i-th filter coefficient for the fractional position x, and a[0]ₓ+a[1]ₓ+a[2]ₓ+ . . . +a[N−1]ₓ=T.

Clause 43. The method of clause 42, wherein the maximum of the fractional position x depends on a precision of intra prediction angle.

Clause 44. The method of clause 43, wherein a value of the fractional position x is larger than 0 and smaller than the precision of intra prediction angle.

Clause 45. The method of clause 43, wherein the precision of intra prediction angle is a number with power of 2.

Clause 46. The method of clause 43, wherein the precision of intra prediction angle is one of 32, 64 or 128.

Clause 47. The method of clause 42, wherein values of filter coefficients of the interpolation filter are in a descending order according to values the fractional position x.

Clause 48. The method of clause 42, wherein values of filter coefficients of the interpolation filter are in an ascending according to values the fractional position x.

Clause 49. The method of clause 42, wherein values of filter coefficients of the interpolation filter are in an ascending if the fractional position x is small than or equals to a value of half of the precision of intra prediction angle; and

values of filter coefficients of the interpolation filter are in a descending if the fractional position x is larger than the value of half of the precision of intra prediction angle.

Clause 50. The method of clause 42, wherein values of filter coefficients of the interpolation filter are in a descending if the fractional position x is small than or equals to a value of half of the precision of intra prediction angle; and

values of filter coefficients of the interpolation filter are in an ascending if the fractional position x is larger than the value of half of the precision of intra prediction angle.

Clause 51. The method of clause 30, information for applying the coding tool is indicated at one of the following: a sequence level, a group of pictures level, a picture level, a slice level, or a tile group level.

Clause 52. The method of clause 51, wherein the information is represented as a syntax element being included in one of: a video parameter set (VPS), a sequence parameter set (SPS), a picture parameter set (PPS), a dependency parameter set (DPS), a decoding capability information (DCI), an adaptation parameter set (APS), a sequence header, a picture header, a sub-picture header, a slice header, or a tile header.

Clause 53. The method of clause 51, wherein the information is indicated at one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

Clause 54. The method of clause 30, wherein the conversion is performed based on coded information.

Clause 55. The method of clause 54, wherein the coded information comprises at least one of the following: a block size, a colour format, a single/dual tree partitioning, a colour component, a slice type, or a picture type.

Clause 56. The method of clause 30, wherein performing the conversion comprises: encoding the current block into the bitstream based on the intra prediction mode.

Clause 57. The method of clause 30, wherein performing the conversion comprises: decoding the current block from the bitstream based on the intra prediction mode.

Clause 58. A method of processing video data, comprising: performing a process on a current block of a video based on a template of the current block, the process being one of the following: a refining process, a process of filtering reference samples, or a process of determining a sample locating at a fractional position; and performing a conversion between the current block and a bitstream of the video.

Clause 59. The method of clause 58, wherein the current block is coded with one of the following: an intra-coded mode, an inter-coded mode, or a combined inter and intra prediction mode.

Clause 60. The method of clause 58, wherein the process is the refining process and performing the process comprises: determining the following for the current block: a first cost, determined by applying the refining process to the template, and a second cost, determined by not applying the refining process to the template; and applying the refining process to the current block based on the first and second costs.

Clause 61. The method of clause 60, wherein applying the refining process to the current block based on the first and second costs comprises: applying the refining process to the current block if: the first cost is smaller than the second cost; or a difference between the second cost and the first is larger than a threshold.

Clause 62. The method of clause 60, wherein applying the refining process comprises: applying the refining process to at least one of the following: predicted samples of the current block, or reconstructed samples of the current block.

Clause 63. The method of clause 60, wherein the refining process is: a filtering process for refining at least one of predicted samples of the current block and reconstructed samples of the current block.

Clause 64. The method of clause 60, wherein the refining process is one of the following: a position dependent intra prediction combination (PDPC) process, or a gradient PDPC process.

Clause 65. The method of clause 58, wherein the process is a process of filtering reference samples and performing the process comprises: determining the following for the current block: a third cost, determined by filtering reference samples of the current block during an intra prediction of the template, and a fourth cost, de determined rived by not filtering the reference samples of the current block during the intra prediction of the template; and filtering the reference samples based on the third and fourth costs.

Clause 66. The method of clause 65, wherein filtering the reference samples based on the third and fourth costs comprises: filtering the reference samples during the intra prediction based on the third if: the third cost is smaller than the fourth cost, or a difference between the fourth cost and the third is larger than a threshold.

Clause 67. The method of clause 58, wherein the process is a process of filtering reference samples and performing the process comprises: determining the following for the current block: a fifth cost, determined by using a first filtering method to filter reference samples during an intra prediction of the template, and a sixth cost, determined by using a second filtering method to filter the reference samples during the intra prediction of the template; and filtering the reference samples based on the fifth and sixth costs.

Clause 68. The method of clause 67, wherein filtering the reference samples based on the fifth and sixth costs comprises one of the following: filtering the reference samples during the intra prediction of the template by using the first filtering method if the fifth cost is smaller than or equals to the sixth cost; or filtering the reference samples during the intra prediction of the template by using the second filtering method if the fifth cost is larger than or equals to the sixth cost.

Clause 69. The method of clause 67, wherein filtering the reference samples based on the fifth and sixth costs comprises one of the following: filtering the reference samples during the intra prediction by using the first filtering method if a difference between the sixth cost and the fifth is larger than or equals to a threshold; or filtering the reference samples during the intra prediction by using the second filtering method if a difference between the sixth cost and the fifth is smaller than or equals to the threshold.

Clause 70. The method of clause 65, wherein the current block is a luma block or a chroma block.

Clause 71. The method of clause 58, wherein the process is a process of determining a sample locating at a fractional position and performing the process comprises: determining the following for the current block: a seventh cost, determined by using a first interpolation filter to determine samples located in fractional positions during an intra prediction of the template, and an eighth cost, determined by using a second interpolation filter to determine the samples located in the fractional positions during the intra prediction of the template; and determining the sample locating at the fractional position based on the seventh and eighth costs.

Clause 72. The method of clause 71, wherein determining the sample locating at the fractional position based on the seventh and eighth costs comprises one of the following: determining the sample locating at the fractional position by using the first interpolation filter if the seventh cost is smaller than or equals to the eighth cost; or determining the sample locating at the fractional position by using the second interpolation filter if the seventh cost is larger than or equals to the eighth cost.

Clause 73. The method of clause 67, wherein determining the sample locating at the fractional position based on the seventh and eighth costs comprises one of the following: determining the sample locating at the fractional position by using the interpolation filter if a difference between the eighth cost and the seventh is larger than or equals to a threshold; or determining the sample locating at the fractional position by using the interpolation filter if a difference between the eighth cost and the seventh is smaller than or equals to a threshold.

Clause 74. The method of clause 58, information for performing the process is indicated at one of the following: a sequence level, a group of pictures level, a picture level, a slice level, or a tile group level.

Clause 75. The method of clause 74, wherein the information is represented as a syntax element being included in one of: a video parameter set (VPS), a sequence parameter set (SPS), a picture parameter set (PPS), a dependency parameter set (DPS), a decoding capability information (DCI), an adaptation parameter set (APS), a sequence header, a picture header, a sub-picture header, a slice header, or a tile header.

Clause 76. The method of clause 74, wherein the information is indicated at one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

Clause 77. The method of clause 58, wherein the conversion is performed based on coded information.

Clause 78. The method of clause 77, wherein the coded information comprises at least one of the following: a block size, a colour format, a single/dual tree partitioning, a colour component, a slice type, or a picture type.

Clause 79. The method of clause 58, wherein performing the conversion comprises: encoding the current block into the bitstream.

Clause 80. The method of clause 58, wherein performing the conversion comprises: decoding the current block from the bitstream.

Clause 81. A method of processing video data, comprising: determining a first intra prediction mode for a first block of a video; determining, based on the first intra prediction mode, a second intra prediction mode for a second block of the video, comprising one of the following: excluding the first intra prediction mode during determining the second intra prediction mode for the second block if the first and second block are in a same video; or including the first intra prediction mode during determining the second intra prediction mode for the second block if the first and second block are in a different video; and performing a conversion between the first and second blocks and a bitstream of the video based on the first and second intra prediction modes.

Clause 82. The method of clause 81, further comprising: applying the first intra prediction mode during at least one of a reconstruction process and a filtering process for the first block.

Clause 83. The method of clause 81, wherein the second block is a neighboring block of the first block and determining the second intra prediction mode for the second block comprises: determining the second intra prediction mode for the second block as the first intra prediction mode is a default mode or the first block is a non-intra coded block.

Clause 84. The method of clause 83, wherein the default mode is one of the following: a planar mode, a DC mode, a horizontal mode, a vertical mode.

Clause 85. The method of clause 81, further comprising: determining a third intra prediction mode for a first block, wherein determining the second intra prediction mode for the second block comprises: constructing, based on the first and third prediction modes, a most probable mode list for the second block; and determining the second intra prediction mode for the second block based on the most probable mode list.

Clause 86. The method of clause 85, wherein constructing the most probable mode comprises: constructing the most probable mode by at least partly excluding the first and third intra prediction modes.

Clause 87. The method of clause 85, wherein the first and third intra prediction modes are derived from neighbouring reconstructed samples of the first block.

Clause 88. The method of clause 85, wherein the most probable mode list is one of the following: a primary most probable mode list, a secondary most probable mode list, or a primary and secondary most probable mode list.

Clause 89. The method of clause 88, wherein constructing the most probable mode comprises at least one of the following: constructing the secondary most probable mode by including the first and third intra prediction modes, constructing the secondary most probable mode by partially including the first and third intra prediction modes, or constructing the primary most probable mode by partially including the first and third intra prediction modes.

Clause 90. The method of clause 81, information for processing video data is indicated at one of the following: a sequence level, a group of pictures level, a picture level, a slice level, or a tile group level.

Clause 91. The method of clause 90, wherein the information is represented as a syntax element being included in one of: a video parameter set (VPS), a sequence parameter set (SPS), a picture parameter set (PPS), a dependency parameter set (DPS), a decoding capability information (DCI), an adaptation parameter set (APS), a sequence header, a picture header, a sub-picture header, a slice header, or a tile header.

Clause 92. The method of clause 90, wherein the information is indicated at one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture.

Clause 93. The method of clause 81, wherein the conversion is performed based on coded information.

Clause 94. The method of clause 93, wherein the coded information comprises at least one of the following: a block size, a colour format, a single/dual tree partitioning, a colour component, a slice type, or a picture type.

Clause 95. The method of clause 81, wherein performing the conversion comprises: encoding the first and second blocks into the bitstream based on the first and second intra prediction modes.

Clause 96. The method of clause 81, wherein performing the conversion comprises: decoding the first and second blocks from the bitstream based on the first and second intra prediction modes.

Clause 97. An apparatus for processing video data, comprising a processor and a non-transitory memory with instructions thereon, wherein the instructions upon execution by the processor, cause the processor to perform a method in accordance with any of clauses 1-29, any of clauses 30-57, any of clauses 58-80 or any of clauses 81-96.

Clause 98. A non-transitory computer-readable storage medium storing instructions that cause a processor to perform a method in accordance with any of clauses 1-29, any of clauses 30-57, any of clauses 58-80 or any of clauses 81-96.

Clause 99. A non-transitory computer-readable recording medium storing a bitstream of a video which is generated by a method performed by a video processing apparatus, wherein the method comprises: performing an intra prediction for a current block of a video based on at least one first parameter different from at least one second parameter used for an intra prediction of a normal angular mode, the current block being used with at least one extended angular mode; and generating a bitstream of the video based on the performing.

Clause 100. A non-transitory computer-readable recording medium storing a bitstream of a video which is generated by a method performed by a video processing apparatus, wherein the method comprises: determining whether an extended angular mode is used for a current block of the video; applying, based on the determining, a coding tool during an intra prediction process during which an intra prediction mode for the current block is determined; and generating the bitstream based on the determining and applying.

Clause 101. A non-transitory computer-readable recording medium storing a bitstream of a video which is generated by a method performed by a video processing apparatus, wherein the method comprises: performing a process on a current block of the video based on a template of the current block, the process being one of the following: a refining process, a process of filtering reference samples, or a process of determining a sample locating at a fractional position; and generating the bitstream based on the performing.

Clause 102. A non-transitory computer-readable recording medium storing a bitstream of a video which is generated by a method performed by a video processing apparatus, wherein the method comprises: determining a first intra prediction mode for a first block of the video; determining, based on the first intra prediction mode, a second intra prediction mode for a second block of the video, comprising one of the following: excluding the first intra prediction mode during determining the second intra prediction mode for the second block if the first and second block are in a same video; or including the first intra prediction mode during determining the second intra prediction mode for the second block if the first and second block are in a different video; and generating the bitstream based on the determining.

Clause 103. A method for storing bitstream of a video, comprising: performing an intra prediction for a current block of a video based on at least one first parameter different from at least one second parameter used for an intra prediction of a normal angular mode, the current block being used with at least one extended angular mode;

generating a bitstream of the video based on the performing ; and storing the bitstream in a non-transitory computer-readable recording medium.

Clause 104. A method for storing bitstream of a video, comprising: determining whether an extended angular mode is used for a current block of the video; applying, based on the determining, a coding tool during an intra prediction process during which an intra prediction mode for the current block is determined; generating the bitstream based on the determining and applying; and storing the bitstream in a non-transitory computer-readable recording medium.

Clause 105. A method for storing bitstream of a video, comprising: performing a process on a current block of the video based on a template of the current block, the process being one of the following: a refining process, a process of filtering reference samples, or a process of determining a sample locating at a fractional position; generating the bitstream based on the performing; and storing the bitstream in a non-transitory computer-readable recording medium.

Clause 106. A method for storing bitstream of a video, comprising: determining a first intra prediction mode for a first block of the video; determining, based on the first intra prediction mode, a second intra prediction mode for a second block of the video, comprising one of the following: excluding the first intra prediction mode during determining the second intra prediction mode for the second block if the first and second block are in a same video; or including the first intra prediction mode during determining the second intra prediction mode for the second block if the first and second block are in a different video; generating the bitstream based on the determining; and storing the bitstream in a non-transitory computer-readable recording medium.

### Example Device

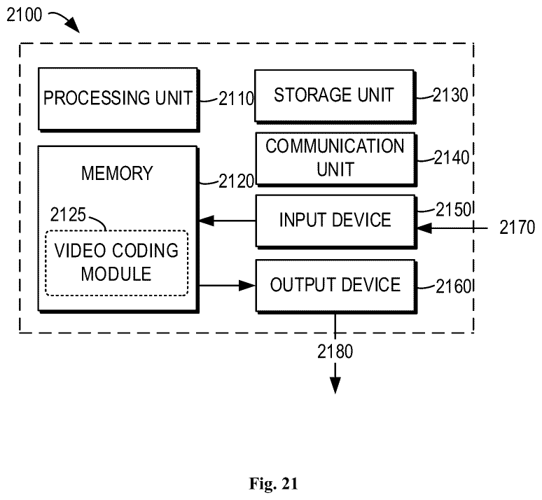

FIG. 21 illustrates a block diagram of a computing device 2100 in which various embodiments of the present disclosure can be implemented. The computing device 2100 may be implemented as or included in the source device 110 (or the video encoder 114 or 200) or the destination device 120 (or the video decoder 124 or 300).

It would be appreciated that the computing device 2100 shown in FIG. 21 is merely for purpose of illustration, without suggesting any limitation to the functions and scopes of the embodiments of the present disclosure in any manner.

As shown in FIG. 21, the computing device 2100 includes a general-purpose computing device 2100. The computing device 2100 may at least comprise one or more processors or processing units 2110, a memory 2120, a storage unit 2130, one or more communication units 2140, one or more input devices 2150, and one or more output devices 2160.

In some embodiments, the computing device 2100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2100 can support any type of interface to a user (such as “wearable” circuitry and the like).

The processing unit 2110 may be a physical or virtual processor and can implement various processes based on programs stored in the memory 2120. In a multi-processor system, multiple processing units execute computer executable instructions in parallel so as to improve the parallel processing capability of the computing device 2100. The processing unit 2110 may also be referred to as a central processing unit (CPU), a microprocessor, a controller or a microcontroller.

The computing device 2100 typically includes various computer storage medium. Such medium can be any medium accessible by the computing device 2100, including, but not limited to, volatile and non-volatile medium, or detachable and non-detachable medium. The memory 2120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2130 may be any detachable or non-detachable medium and may include a machine-readable medium such as a memory, flash memory drive, magnetic disk or another other media, which can be used for storing information and/or data and can be accessed in the computing device 2100.

The computing device 2100 may further include additional detachable/non-detachable, volatile/non-volatile memory medium. Although not shown in FIG. 21, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2140 communicates with a further computing device via the communication medium. In addition, the functions of the components in the computing device 2100 can be implemented by a single computing cluster or multiple computing machines that can communicate via communication connections. Therefore, the computing device 2100 can operate in a networked environment using a logical connection with one or more other servers, networked personal computers (PCs) or further general network nodes.

The input device 2150 may be one or more of a variety of input devices, such as a mouse, keyboard, tracking ball, voice-input device, and the like. The output device 2160 may be one or more of a variety of output devices, such as a display, loudspeaker, printer, and the like. By means of the communication unit 2140, the computing device 2100 can further communicate with one or more external devices (not shown) such as the storage devices and display device, with one or more devices enabling the user to interact with the computing device 2100, or any devices (such as a network card, a modem and the like) enabling the computing device 2100 to communicate with one or more other computing devices, if required. Such communication can be performed via input/output (I/O) interfaces (not shown).

In some embodiments, instead of being integrated in a single device, some or all components of the computing device 2100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2100 may be used to implement video encoding/decoding in embodiments of the present disclosure. The memory 2120 may include one or more video coding modules 2125 having one or more program instructions. These modules are accessible and executable by the processing unit 2110 to perform the functionalities of the various embodiments described herein.

In the example embodiments of performing video encoding, the input device 2150 may receive video data as an input 2170 to be encoded. The video data may be processed, for example, by the video coding module 2125, to generate an encoded bitstream. The encoded bitstream may be provided via the output device 2160 as an output 2180.

In the example embodiments of performing video decoding, the input device 2150 may receive an encoded bitstream as the input 2170. The encoded bitstream may be processed, for example, by the video coding module 2125, to generate decoded video data. The decoded video data may be provided via the output device 2160 as the output 2180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1-106. (canceled)

107. A method of processing video data, comprising:
performing, during a conversion between a current block of a video and a bitstream of the video, an intra prediction for the current block based on at least one first parameter different from at least one second parameter used for an intra prediction of a normal angular mode, at least one extended angular mode being used for the current block; and
performing the conversion based on the intra prediction mode.

108. The method of claim 107,
wherein the at least one extended angular mode is determined by at least one of the following: neighbouring samples, or neighbouring pixels, and/or
wherein the current block is coded using one of the following: a decoder side intra mode derivation mode, an intra prediction mode, an intra prediction with subpartitions mode, or an intra prediction with multiple reference lines mode, and/or
wherein the at least one extended angular mode is determined from a predefined set, and/or
wherein the predefined set comprises at least one intra prediction mode with wide angle if the current block is non-square, and the number of intra prediction modes with wide angle used for the predefined set is larger than a preset value, and/or
wherein the at least one first parameter is determined using intra prediction angles, and/or
wherein the at least one first parameter is indicated at one of the following: a sequence level, a group of pictures level, a picture level, a slice level, or a tile group level, and/or
wherein the at least one first parameter is represented as a syntax element being included in one of: a video parameter set (VPS), a sequence parameter set (SPS), a picture parameter set (PPS), a dependency parameter set (DPS), a decoding capability information (DCI), an adaptation parameter set (APS), a sequence header, a picture header, a sub-picture header, a slice header, or a tile header, and/or
wherein the at least one parameter is indicated at one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a sub-picture, and/or
wherein the conversion is performed based on coded information and the coded information comprises at least one of the following: a block size, a colour format, a single/dual tree partitioning, a colour component, a slice type, or a picture type, and/or
wherein performing the conversion comprises: encoding the current block into the bitstream based on the intra prediction mode and/or decoding the current block from the bitstream based on the intra prediction mode.

109. The method of claim 108,
wherein the at least one extended angular mode comprised in the predefined set is indicated in the bitstream or derived at an encoder or decoder, and/or
wherein an extended angular mode of the predefined set is derived from two pre-defined angular modes comprised in an intra prediction mode set predefined for intra prediction, the two pre-defined angular modes being adjacent or non-adjacent to each other.

110. The method of claim 109,
wherein an angle value of the extended angular mode is between angle values of the two pre-defined angular modes, and/or
wherein an angle precision of the extended angular mode is higher than at least one of angle precisions of the two pre-defined angular modes, and/or
wherein the angle precision of the extended angular mode is 1/64 or 1/128.

111. The method of claim 109, wherein an angle precision of the at least one intra prediction modes with wide angle is higher than a predefined angle precision.

112. The method claim 111,
wherein the at least one first parameter is further determined using a first value and a second value, the product of the first and second values is larger than or equals to 512*32, and/or
wherein the first value is 512 and the second value is 64, or the first value is 1024 and the second value is 32, and/or
wherein the at least one first parameter is an inverse angular parameter and derived by: inverse angular parameter=function (first value*second value/intra prediction angles), wherein the function is a function of round or a function of ceiling.

113. The method of claim 107, further comprising:
determining, based on the extended angular mode, a further intra prediction mode for a further block, and/or
performing a process on a current block of a video based on a template of the current block, the process being one of the following:
a refining process,
a process of filtering reference samples, or
a process of determining a sample locating at a fractional position.

114. The method of claim 113,
wherein the current block and the further block are in the same picture, sub-picture or slice or tile of the video, and/or
wherein the further block is adjacent or non-adjacent to the current block, and/or
wherein determining the further intra prediction mode comprises: constructing, based on the extended angular mode, a most probable mode list for the further block of the video; and determining the further intra prediction mode based on the most probable mode list.

115. The method of claim 114,
wherein constructing the most probable mode list based on the extended angular mode comprises one of the following: including the extended angular mode into the most probable mode list; or excluding the extended angular mode from the most probable mode list, and/or
wherein constructing the most probable mode list based on the extended angular mode comprises: mapping the extended angular mode to a predefined angular mode; and including the mapped predefined angular mode into the most probable mode list, and wherein the predefined angular mode is a normal angular mode nearest to the extended angular mode.

116. The method of claim 107, further comprising:
determining, during a conversion between a current block of a video and a bitstream of the video, whether an extended angular mode is used for the current block;
applying, based on the determining, a coding tool during an intra prediction process during which an intra prediction mode for the current block is determined; and
performing the conversion based on the intra prediction mode.

117. The method of claim 116,
wherein the coding tool is one of the following: a smooth filter, a position dependent intra prediction combination (PDPC) filter, a gradient PDPC filter, or an interpolation filter, and/or
wherein applying the coding tool comprises: applying at least one interpolation filter with a first precision different from a second precision to generate samples at fractional positions, the second precision being used for a situation where a normal angular mode is used for the current block, and wherein the first precision is higher than the second precision.

118. The method of claim 117, wherein applying the coding tool comprises one of the following:
applying the at least one interpolation filter with the first precision based on colour components, or
applying the at least one interpolation filter with the first precision to a first colour component; and applying at least one interpolation filter with the second precision to a second colour component,
and where either the first or second colour components is one of the following:
a colour component Y, Cb or Cr in a YCbCr format, or
a colour component R, G and B in an RGB format.

119. The method of claim 117,
wherein applying the at least one interpolation filter with the first precision comprises: applying the at least one interpolation filter with the first precision if an extended angular mode is used for the current block, and/or
wherein the at least one interpolation filter with the first precision belongs to an interpolation filter set allowed to be used for a situation where an extended angular mode is used for the current block, and wherein different interpolation filters comprised in the interpolation filter set are defined for different extended angular modes, and/or
wherein the at least one interpolation filter with the first precision is derived at a decoder or included in the bitstream, and/or
wherein a precision of the interpolation filter equals to 1/T, wherein T is an integer equaling to T=2^{K}, where K is an integer lager than 6, and/or
wherein an interpolation filter of the at least one interpolation filter is a N-tap filter using N samples to interpolate a sample at a fractional position, wherein N is the number of taps of the interpolation filter; and wherein the interpolation filter is defined by: f(x)=[a[0]ₓ, a[1]ₓ, a[2]ₓ, . . . a[N−1]ₓ], where, x represents a fractional position, a[i]ₓ represents the i-th filter coefficient for the fractional position x, and a[0]ₓ+a[1]ₓ+a[2]ₓ+ . . . +a[N−1]ₓ=T, and/or wherein the maximum of the fractional position x depends on a precision of intra prediction angle, and/or wherein a value of the fractional position x is larger than 0 and smaller than the precision of intra prediction angle, and/or wherein the precision of intra prediction angle is a number with power of 2, and/or where the precision of intra prediction angle is one of 32, 64 or 128.

120. The method of claim 119,
wherein values of filter coefficients of the interpolation filter are in a descending order according to values the fractional position x, and/or
wherein values of filter coefficients of the interpolation filter are in an ascending according to values the fractional position x, and/or
wherein values of filter coefficients of the interpolation filter are in an ascending if the fractional position x is small than or equals to a value of half of the precision of intra prediction angle; and values of filter coefficients of the interpolation filter are in a descending if the fractional position x is larger than the value of half of the precision of intra prediction angle, and/or where values of filter coefficients of the interpolation filter are in a descending if the fractional position x is small than or equals to a value of half of the precision of intra prediction angle; and values of filter coefficients of the interpolation filter are in an ascending if the fractional position x is larger than the value of half of the precision of intra prediction angle.

121. The method of claim 113,
wherein the current block is coded with one of the following: an intra-coded mode, an inter-coded mode, or a combined inter and intra prediction mode, and/or wherein the process is the refining process and performing the process comprises:
determining the following for the current block: a first cost, determined by applying the refining process to the template and a second cost, determined by not applying the refining process to the template; and applying the refining process to the current block based on the first and second costs, and/or
wherein the process is a process of filtering reference samples and performing the process comprises: determining the following for the current block: a third cost, determined by filtering reference samples of the current block during an intra prediction of the template, and a fourth cost, de determined rived by not filtering the reference samples of the current block during the intra prediction of the template; and filtering the reference samples based on the third and fourth costs, and/or
wherein the process is a process of determining a sample locating at a fractional position and performing the process comprises: determining the following for the current block: a seventh cost, determined by using a first interpolation filter to determine samples located in fractional positions during an intra prediction of the template, and an eighth cost, determined by using a second interpolation filter to determine the samples located in the fractional positions during the intra prediction of the template; and determining the sample locating at the fractional position based on the seventh and eighth costs.

122. The method of claim 107, further comprising:
determining a first intra prediction mode for a first block of a video;
determining, based on the first intra prediction mode, a second intra prediction mode for a second block of the video, comprising one of the following:
excluding the first intra prediction mode during determining the second intra prediction mode for the second block if the first and second block are in a same video; or
including the first intra prediction mode during determining the second intra prediction mode for the second block if the first and second block are in a different video; and
performing a conversion between the first and second blocks and a bitstream of the video based on the first and second intra prediction modes.
and/or wherein method further comprises:
determining a third intra prediction mode for a first block, wherein determining the second intra prediction mode for the second block comprises:
constructing, based on the first and third prediction modes, a most probable mode list for the second block; and
determining the second intra prediction mode for the second block based on the most probable mode list.

123. The method of claim 122,
wherein the second block is a neighboring block of the first block and determining the second intra prediction mode for the second block comprises: determining the second intra prediction mode for the second block as the first intra prediction mode is a default mode or the first block is a non-intra coded block, and the default mode is one of the following: a planar mode, a DC mode, a horizontal mode, a vertical mode, and/or
wherein constructing the most probable mode comprises: constructing the most probable mode by at least partly excluding the first and third intra prediction modes.

124. The method of claim 122,
wherein the first and third intra prediction modes are derived from neighbouring reconstructed samples of the first block, and/or
wherein the most probable mode list is one of the following: a primary most probable mode list, a secondary most probable mode list, or a primary and secondary most probable mode list, and wherein constructing the most probable mode comprises at least one of the following:
constructing the secondary most probable mode by including the first and third intra prediction modes,
constructing the secondary most probable mode by partially including the first and third intra prediction modes, or
constructing the primary most probable mode by partially including the first and third intra prediction modes.

125. An apparatus for processing video data comprising a processor and a non-transitory memory with instructions thereon, wherein the instructions upon execution by the processor, cause the processor to perform a method comprising:
performing, during a conversion between a current block of a video and a bitstream of the video, an intra prediction for the current block based on at least one first parameter different from at least one second parameter used for an intra prediction of a normal angular mode, at least one extended angular mode being used for the current block; and
performing the conversion based on the intra prediction mode.

126. A non-transitory computer-readable storage medium storing instructions that cause a processor to perform a method comprising:
performing, during a conversion between a current block of a video and a bitstream of the video, an intra prediction for the current block based on at least one first parameter different from at least one second parameter used for an intra prediction of a normal angular mode, at least one extended angular mode being used for the current block; and
performing the conversion based on the intra prediction mode.
